(19) United States
(12) Patent Application Publication
(10) Pub. No.: US 2024/0009845 A1
(43) Pub. Date: Jan. 11, 2024

(54) SYSTEMS, METHODS, AND USER INTERFACES EMPLOYING CLEARANCE DETERMINATIONS IN ROBOT MOTION PLANNING AND CONTROL

(71) Applicant: REALTIME ROBOTICS, INC., Boston, MA (US)

(72) Inventors: William Floyd-Jones, Boston, MA (US); Sean Murray, Cambridge, MA (US); Ty Tremblay, Medford, MA (US)

(21) Appl. No.: 18/039,814

(22) PCT Filed: Dec. 1, 2021
(86) PCT No.: PCT/US2021/061427

§ 371 Date: Jun. 1, 2023

Related U.S. Application Data
(60) Provisional application No. 63/120,412, filed on Dec. 2, 2020.

(51) Int. Cl. B25J 9/16

(52) U.S. Cl. CPC B25J 9/1666; B25J 9/1697

(57) ABSTRACT

Systems, methods and user interfaces employ clearance or margin determinations in motion planning and motion control for robots in operational environments, the clearance or margin determinations representing an amount of clearance or margin between at least one portion of a robot and one or more objects in the operational environment. Clearances may be displayed in a presentation of motion, for instance displayed in a presentation of a roadmap or a number of paths in a representation of a three-dimensional environment in which the robot operates. Roadmaps may be adjusted based at least in part of determined clearances, for instance based on user input or autonomously.

### TECHNICAL FIELD

The present disclosure generally relates to robots, and in particular to systems, methods and user interfaces used in robot motion planning and control, for instance systems, methods and user interfaces that employ clearance or margin determinations in motion planning and motion control for robots in operational environments, the clearance or margin determinations representing an amount of clearance or margin between at least one portion of a robot and one or more objects in the operational environment.

### BACKGROUND

### Description of the Related Art

Robots are becoming increasing ubiquitous in a variety of applications and environments.

Typically, a processor-based system performs motion planning and/or control of the robot(s). The processor-based system may, for example include a processor communicatively coupled to one or more sensors (e.g., cameras, contact sensors, force sensors, encoders). The processor-based system may determine and/or execute motion plans to cause a robot to execute a series of tasks. Motion planning is a fundamental problem in robot control and robotics. A motion plan specifies a path that a robot can follow from a starting state to a goal state, typically to complete a task without colliding with any objects (e.g., static obstacles, dynamic obstacles, including humans), in an operational environment or with a reduced possibility of colliding with any objects in the operational environment. Challenges to motion planning involve the ability to perform motion planning at very fast speeds even as characteristics of the environment change. For example, characteristics such as location or orientation of one or more objects in the environment may change over time. Challenges further include performing motion planning using relatively low cost equipment, with relatively low energy consumption, and with limited amounts of storage (e.g., memory circuits, for instance on processor chip circuitry).

Motion planning is typically performed using a data structure called a roadmap, often interchangeably referred to as a motion planning graph. A roadmap comprises a plurality of nodes and a plurality of edges, each edge coupling the nodes of a respective pair of the nodes. The nodes, often interchangeably referred to as vertices, hubs, waypoints, or via points, correspond to robot poses or configurations. The edge between two nodes of a pair of nodes corresponds to a motion or transition from one pose of the robot represented by one of the nodes of the pair to the other pose of the robot represented by the other one of the nodes of the pair of nodes.

### BRIEF SUMMARY

One of the goals in motion planning for a robot is to avoid, or at least reduce the possibility of, collisions by the robot with objects in the operational environment. Those objects may include static objects, for example with positions known before a runtime operation of the robot. Those objects may additionally or alternatively include dynamic objects (e.g., another robot, humans), where the position or location of the object may change during the runtime operation of the robot.

In addition to avoiding collisions, it may be particularly advantageous to understand and take into account an amount of clearance or margin between a robot or portion thereof and the objects in the operational environment. In some instances, certain clearances may be more relevant than other clearances. In some instances, different amounts of clearance may be desirable for different portions of the robot or for different operations. For example, a larger amount of clearance may be desired for a weld gun end of arm tool of a robot than is desired for an elbow of the robot.

To help ensure sufficient clearances exist, engineers will often dilate a size of part or all of a robot. Thus, if the dilated robot moves without collisions, there is increased confidence that the clearances are sufficient. Nevertheless, even this approach can fail, due to at least two reasons. First, sometimes no solution exists that provides sufficient clearances through an entire range of motion. The static objects (e.g., static obstacles) simply do not permit the desired clearance during the movements. Second, sometimes the real world differs enough from a model employed by a simulator that the clearances are no longer sufficient. Thus, while a motion plan may have sufficient clearance in a simulated workcell, those clearances are not sufficient when applied to a real world workcell. Thus, while a user or operator may attempt to assess clearances visually, such is particularly difficult to perform with any reasonable degree of accuracy.

The approaches described herein allow engineers to simulate or execute a motion plan and instead of simply “eyeballing” the clearances, advantageously see specific visual indications of a size and location of the clearances for one or more portions of a robot during or along one or more movements of the robot or portion thereof. The provision of specific visual indications of clearance allows the engineers to quickly and intuitively focus in on precisely where to adjust a motion plan, for example by adjusting the values of various parameters for slowing motion around a tight clearance, employing more conservative path smoothing, or by adding or removing nodes or edges in the roadmap and/or adjusting nodes or edges in the roadmap.

Thus, it would be particularly advantageous to computationally determine clearances for one or more portions of a robot with respect to one or more objects in the operational environment, and present visual indications of the determined clearances for review. For instance, visual indications of the determined amount of clearance for one, two, more, or even all portions of a robot or a robotic appendage may be visually presented in a representation of motion of a robot. The representation of motion may, for example, take the form of a representation of a three-dimensional (3D) space in which the robot operates, for instance as one or more paths of robot movements. The representation of motion may, for example, take the form of a roadmap or graph representation showing nodes representing poses and edges corresponding to transitions or robot movements between poses. The amount of clearance may be determined with respect to one or more objects, even including another robot operating in the operational environment. In some implementations, indications of the determined amount of clearance may be presented for one, two or even more robots operating in the operational environment.

The determined amount of clearance for one or more portions of a robot may be presented as a value, for example a numeric value (e.g., millimeters, centimeters, inches). The determined amount of clearance for one or more portions of a robot may be presented as a color (e.g., red, orange, yellow, green, blue), for example a color that corresponds to an amount of clearance or even corresponds to a deviation from a specified nominal amount of clearance. The determined amount of clearance for one or more portions of a robot may be presented as a heat map, for example with a transition of colors and/or shades of colors (e.g., dark red, light red, light green, dark green) that corresponds to an amount of clearance or even corresponds to a deviation from a specified nominal amount of clearance. The determined amount of clearance for one or more portions of a robot may be presented as a cue or visual effect, for instance as a line weight or other visual effect (e.g., marqueeing, flashing).

The visually presented indication of the determined amount of clearance may, for example, be spatially associated with a corresponding motion or movement, for example the indication of the determined amount of clearance may be spatially associated with a path or portion thereof in a 3D representation of space or spatially associated with an edge or portion thereof in a roadmap or graph representation. The visually presented indication of the determined amount of clearance may, for example, be spatially associated with the robot, or portion thereof, in a representation of movement, for instance in a simulation of the robot or portion thereof moving in a representation of 3D space, for instance by applying a color to a perimeter of the robot or portion thereof where the color corresponds to a computationally determined amount of clearance.

The visually presented indication of the determined amount of clearance may, for example, represent a smallest clearance experienced by the entire robot in executing a motion. The visually presented indication of the determined amount of clearance may, for example, represent a smallest clearance experienced by a respective portion (e.g., robotic appendage; link, joint, end of arm tool or tool center point (TCP) of robotic appendage) of the robot in executing a motion. For example, a visually presented indication of the determined amount of clearance may represent an amount of clearance experienced by an end of arm tool, end effector or tool center point, a specific link, or a specific joint, during a specified movement.

Each motion may have a respective single indication of determined clearance, representing a smallest clearance experienced over an entire range of the motion. Alternatively, each motion may have a plurality of indications of clearance, each indication of clearance representing a smallest clearance experienced at respective points along the range of the motion.

Conventionally, motion planning includes removing edges from a roadmap where the motions corresponding to the edges are in conflict with a current environment (e.g., collision or significant likelihood of collision), and then solving a shortest-path search from a current node to a goal node or one of several possible goal nodes. The shortest path search can incorporate a cost metric, in which each edge has a cost. The cost metric reflects one or more parameters of concern (e.g., latency, energy cost). In at least one implementation of the approach described herein, the cost metric may be augmented (e.g., via a cost function) to incorporate determined clearance information. This may advantageously allow production of roadmaps that represent determined clearances and/or motion plans that are clearance-aware.

In at least one implementation, a user interface is provided that allows adjustment of roadmaps, for example based at least in part on determined clearances. For example, the nodes and edges of a roadmap in the form of a visually presented graph may take the form of user selectable icons which can be removed, moved, added, or have parameters associated therewith adjusted via user input. Additionally or alternatively, a menu or palate of user selectable icons may allow nodes and edges of a roadmap to be modified (e.g., removed, moved, copied or duplicated and/or values of parameters adjusted), or allow new nodes or edges to be added to the roadmap. Thus, robot motion may be adjusted based on received input. Additionally or alternatively, robot motion may be adjusted automatically and autonomously (i.e., without user or operator input or intervention) based on one or more determined clearances.

The described approaches may be employed in motion planning performed during a simulated operation of the robot during a pre-runtime or configuration time and/or performed during a runtime operation of the robot.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a schematic diagram of a processor-based system to perform motion planning for one or more robots, according to one illustrated implementation, along with a plurality of robots that operate in an operational environment to carry out tasks.

FIG. 2 is a functional block diagram of the processor-based system of FIG. 1, communicatively coupled to control a first robot of the plurality of robots.

FIG. 3 is an example roadmap for a robot that operates in an operational environment or workcell, according to one illustrated implementation.

FIG. 4 is an example representation of movement in a three-dimensional environment in which a robot operates including a number of paths followed by portions of the robot.

FIG. 5 is a flow diagram showing a method of operation in a processor-based system of FIGS. 1 and 2 to determine clearances for two or more portions of a robot and to present a representation of robot movement as either paths in a three-dimensional space representation or as edges in a roadmap along with visual indications of the determined clearances for the two or more portions of the robot in the presentation of the representation of movement, according to at least one illustrated implementation.

FIG. 6 is a flow diagram showing a method of operation in a processor-based system of FIGS. 1 and 2 to determine clearances for at least one of two or more robots that operate in an operational environment, and to present a representation of movement of at least one of the robots in a three-dimensional space representation along with visual indications of the determined clearances in the three-dimensional space representation, according to at least one illustrated implementation.

FIG. 7 is a flow diagram showing a method of operation in a processor-based system of FIGS. 1 and 2 to determine clearances for one or more portions of a robot and to set or adjust cost metrics associated with respective edges of a roadmap based at least in part on the determined clearances, according to at least one illustrated implementation.

FIG. 8 is a flow diagram showing a method of operation in a processor-based system of FIGS. 1 and 2 to set or adjust cost metrics associated with respective edges, according to at least one illustrated implementation, executable as part of the method illustrated in FIG. 7.

FIG. 9 is a flow diagram showing a method of operation in a processor-based system of FIGS. 1 and 2 to set or adjust cost metrics associated with respective edges, according to at least one illustrated implementation, executable as part of the method illustrated in FIG. 7.

FIG. 10 is a flow diagram showing a method of operation in a processor-based system of FIGS. 1 and 2 to determine clearances for portions of a robot, to provide visual indications of the determined clearances, to receive input and to adjust motion of a robot based at least in part on the received input, according to at least one illustrated implementation.

FIG. 11 is a flow diagram showing a method of operation in a processor-based system of FIGS. 1 and 2 to provide a user interface that allows adjustment of at least a portion of a roadmap in order to adjust movement or motion of one or more robots, according to at least one illustrated implementation.

FIG. 12 is a flow diagram showing a method of operation in a processor-based system of FIGS. 1 and 2 to provide a graphical user interface that allows adjustment of movement or motion of one or more robots, according to at least one illustrated implementation.

FIG. 13 is a flow diagram showing a method of operation in a processor-based system of FIGS. 1 and 2 to provide visual indications of determined clearances as one or more numerical values associated with respective edges or paths, according to at least one illustrated implementation.

FIG. 14 is a flow diagram showing a method of operation in a processor-based system of FIGS. 1 and 2 to provide visual indications of determined clearances as one or more colors associated with respective edges or paths, according to at least one illustrated implementation.

FIG. 15 is a flow diagram showing a method of operation in a processor-based system of FIGS. 1 and 2 to provide visual indications of determined clearances as one or more heat maps associated with respective edges or paths, according to at least one illustrated implementation.

FIG. 16 is an image of a displayed user interface showing a presentation of a representation of movement of a robot or portions thereof along with indications of determined clearances according to at least one illustrated implementation in which the representation of movement is in the form of a roadmap and the indications of determined clearances are in the form of a single numeric value representing a smallest clearance experienced by one or more portions of the robot in a movement corresponding to a transition represented by an edge in the roadmap.

FIG. 17 is an image of a displayed user interface showing a presentation of a representation of movement of a robot or portions thereof along with indications of determined clearances according to at least one illustrated implementation in which the representation of movement is in the form of a roadmap and the indications of determined clearances are in the form of a plurality of numeric values representing respective clearances experienced respective portions of the robot in a movement corresponding to a transition represented by an edge in the roadmap.

FIG. 18 is an image of a displayed user interface showing a presentation of a representation of movement of a robot or portions thereof along with indications of determined clearances according to at least one illustrated implementation in which the representation of movement is in the form of a roadmap and the indications of determined clearances are in the form of a single color representing a smallest clearance experienced by one or more portions of the robot in executing a movement corresponding to a transition represented by an edge in the roadmap.

FIG. 19 is an image of a displayed user interface showing a presentation of a representation of movement of a robot or portions thereof along with indications of determined clearances according to at least one illustrated implementation in which the representation of movement is in the form of a roadmap and the indications of determined clearances are in the form of a plurality of colors of a heat map representing respective clearances experienced respective portions of the robot in executing a movement corresponding to a transition represented by an edge in the roadmap.

FIG. 20 is an image of a displayed user interface showing a presentation of a representation of movement of a robot or portions thereof along with indications of determined clearances according to at least one illustrated implementation in which the representation of movement is in the form of one or more paths in a representation of a three-dimensional operational environment and the indications of determined clearances are in the form of a single numeric value representing a smallest clearance experienced by the robot in executing movements represented by the paths in the representation of the three-dimensional operational environment.

FIG. 21 is an image of a displayed user interface showing a presentation of a representation of movement of a robot or portions thereof along with indications of determined clearances according to at least one illustrated implementation in which the representation of movement is in the form of one or more paths in a representation of a three-dimensional operational environment and the indications of determined clearances are in the form of a plurality of numeric values representing respective clearances experienced by the robot in executing movements represented by the paths in the representation of the three-dimensional operational environment.

FIG. 22 is an image of a displayed user interface showing a presentation of a representation of movement of a robot or portions thereof along with indications of determined clearances according to at least one illustrated implementation in which the representation of movement is in the form of one or more paths in a representation of a three-dimensional operational environment and the indications of determined clearances are in the form of a single color representing a smallest clearance experienced by the robot in executing movements represented by the paths in the representation of the three-dimensional operational environment.

FIG. 23 is an image of a displayed user interface showing a presentation of a representation of movement of a robot or portions thereof along with indications of determined clearances according to at least one illustrated implementation in which the representation of movement is in the form of one or more paths in a representation of a three-dimensional operational environment and the indications of determined clearances are in the form of a plurality of colors of a heat map representing respective clearances experienced by the robot in executing movements represented by the paths in the representation of the three-dimensional operational environment.

FIG. 24 is an image of a displayed user interface showing a presentation of a representation of movement of two or more portions of a robot along with indications of determined clearances according to at least one illustrated implementation in which the representation of movement is in the form of two or more paths in a representation of a three-dimensional operational environment and the indications of determined clearances are in the form of a single numeric value representing a smallest clearance experienced by each of the two or more portions of the robot in executing movements represented by the paths in the representation of the three-dimensional operational environment.

FIG. 25 is an image of a displayed user interface showing a presentation of a representation of movement of two or more portions of a robot along with indications of determined clearances according to at least one illustrated implementation in which the representation of movement is in the form of two or more paths in a representation of a three-dimensional operational environment and the indications of determined clearances are in the form of a plurality of numeric values representing respective clearances experienced by each of the two or more portions of the robot in executing movements represented by the paths in the representation of the three-dimensional operational environment.

FIG. 26 is an image of a displayed user interface showing a presentation of a representation of movement of two or more portions of a robot of along with indications of determined clearances according to at least one illustrated implementation in which the representation of movement is in the form of two or more paths in a representation of a three-dimensional operational environment and the indications of determined clearances are in the form of a single color representing a smallest clearance experienced by each of the two or more portions of the robot in executing movements represented by the paths in the representation of the three-dimensional operational environment.

FIG. 27 is an image of a displayed user interface showing a presentation of a representation of movement of two or more portions of a robot along with indications of determined clearances according to at least one illustrated implementation in which the representation of movement is in the form of two or more paths in a representation of a three-dimensional operational environment and the indications of determined clearances are in the form of a plurality of colors of a heat map representing respective clearances experienced by each of the two or more portions of the robot in executing movements represented by the paths in the representation of the three-dimensional operational environment.

FIG. 28 is an image of a displayed user interface showing a presentation of a representation of movement of two or more portions of a robot along with indications of determined clearances according to at least one illustrated implementation.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with processor-based systems, computer systems, actuators, actuator systems, and/or communications networks or channels have not been shown or described in detail to avoid unnecessarily obscuring descriptions of the embodiments. In other instances, well-known motion planning methods and techniques and/or computer vision methods and techniques for generating perception data and volumetric representations of one or more objects and the like have not been described in detail to avoid unnecessarily obscuring descriptions of the embodiments.

Unless the context requires otherwise, throughout the specification and claims that follow, the word “comprise” and variations thereof, such as, “comprises” and “comprising” are to be construed in an open, inclusive sense that is as “including, but not limited to.”

Reference throughout this specification to “one implementation” or “an implementation” or to “one embodiment” or “an embodiment” means that a particular feature, structure or characteristic described in connection with the embodiment is included in at least one implementation or in at least one implementation embodiment. Thus, the appearances of the phrases “one implementation” or “an implementation” or “in one embodiment” or “in an embodiment” in various places throughout this specification are not necessarily all referring to the same implementation or embodiment. Furthermore, the particular features, structures, or characteristics may be combined in any suitable manner in one or more implementations or embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used in this specification and the appended claims, the terms “module” or “modules” when not immediately preceded by “program” or “logic” means circuitry (e.g., processor for instance a microprocessor, microcontroller, central processing unit (CPU), CPU core, application specific integrated circuit (ASIC), field programmable gate array (FPGA)) that executes logic (e.g., a set of instructions or algorithm) defined in hardware, software and/or firmware.

As used in this specification and the appended claims, the terms “program module” or “program modules” means logic that can be executed in the form of a set of instructions or an algorithm stored in nontransitory media.

As used in this specification and the appended claims, the terms “robot” or “robots” means both robot or robots and/or portions of the robot or robots. While generally discussed in terms of a robot, the various structures, acts and/or operations are applicable to operational environments with one, two or even more robots operating therein.

As used in this specification and the appended claims, the terms “operational environment” or “environment” are used to refer to a volume, space or workcell in which one, two or more robots operate. The operational environment may include various objects, for example obstacles (i.e., items which the robots are to avoid) and/or work pieces (i.e., items with which the robots are to interact with or act on).

As used in this specification and the appended claims, the term “path” means a set or locus of points in two- or three-dimensional space, and the term “trajectory” means a path that includes times at which certain ones of those points will be reached, and may optionally include velocity, and/or acceleration values as well.

As used in this specification and the appended claims, the terms “three-dimensional space representation” or “3D-space representation” means a representation of a three-dimensional or 3D operational environment in which one or more robots operate, whether visually represented in a presentation or display of two-dimensional or three-dimensional images, or as logically represented in a data structure stored in non-transitory processor-readable media.

As used in this specification and the appended claims, the terms “roadmap” and “roadmaps” are used interchangeably with the terms “motion planning graph” and “motion planning graphs” and means a graph representation that includes a plurality of nodes and a plurality of edges, each edge coupling the nodes of a respective pair of nodes, the nodes representing respective states, configurations or poses of a robot, and the edges representing legal or valid respective transitions between a respective pair of the states, configurations or poses of the robot that are represented by the nodes of the pair of nodes coupled by the respective edge, whether visually represented in a presentation or display of two-dimensional or three-dimensional images, or as logically represented in a data structure stored in non-transitory processor-readable media. States, configurations or poses may, for example, represent sets of joint positions, orientations, poses, or coordinates for each of the joints of the respective robot 102. Thus, each node may represent a pose of a robot 102 or portion of the robot 102 as completely defined by the poses of the joints comprising the robot 102.

As used in this specification and the appended claims, the term “task” is used to refer to a robotic task in which a robot transitions from a pose A to a pose B preferably without colliding with obstacles in its environment. The task may perhaps involve the grasping or un-grasping of an item, moving or dropping an item, rotating an item, or retrieving or placing an item. The transition from pose A to pose B may optionally include transitioning between one or more intermediary poses.

As used in this specification and the appended claims, the terms “color” and “colors” refer to human-perceptibly distinguishable colors (e.g., red, orange, green, blue) as well as human-perceptibly distinguishable shades of color, whether those differences in color or shades of color are due to differences in hue, value, saturation and/or color temperature.

As used in this specification and the appended claims, the terms “determine”, “determining” and “determined” when used in the context of whether a collision will occur or result, mean that an assessment or prediction is made as to whether a given pose or movement between two poses via a number of intermediate poses will result in a collision between a portion of a robot and some object (e.g., another portion of the robot, a portion of another robot, a persistent obstacle, a transient obstacle).

As used in this specification and the appended claims, the terms “determine,” “determining” and “determined” when used in the context of an clearance or margin, mean that a computational assessment or prediction is made via a processor as to an amount of distance or space that would exist or exists between a robot or portion thereof and one or more objects in the operational environment when executing a motion or movement of the robot or portion thereof, for example a motion or movement along a path or motion or movement represented by an edge in a roadmap.

As used in this specification and the appended claims, the terms “sensor” or “sensors” includes the sensor(s) or transducer(s) that detects physical characteristics of the operational environment, as well as any transducer(s) or other source(s) of energy associated with such detecting sensor or transducer, for example transducers that emit energy which is reflected, refracted or otherwise returned, for instance light emitting diodes, other light sources, lasers and laser diodes, speakers, haptic engines, sources of ultrasound energy, etc.

As used in this specification and the appended claims, reference to operation or movement or motion of a robot includes operation or movement or motion of an entire robot, and/or operation or movement or motion of a portion (e.g., robotic appendage, end of arm tool, end effector) of a robot.

At least some implementations are described with respect to operation (e.g., motion planning, clearance determination) from the perspective of a given robot (e.g., a first robot), for instance motion planning for a first robot, for example where there are one or more other robots present in the operational environment. The references to “other robots” in such descriptions mean any other robots in the environment other than the particular robot for which the specific instance of the operation being described is being performed. It is noted that similar operations may be concurrently performed for two or more different robots, and from the perspective of the motion planning and clearance determination operations for a first one of the robots, a second one of the robots is considered as the other robot. While from the perspective of the motion planning and clearance determination operations for the second one of the robots, the first one of the robots is considered as constituting the other robot.

The headings and Abstract of the Disclosure provided herein are for convenience only and do not interpret the scope or meaning of the embodiments.

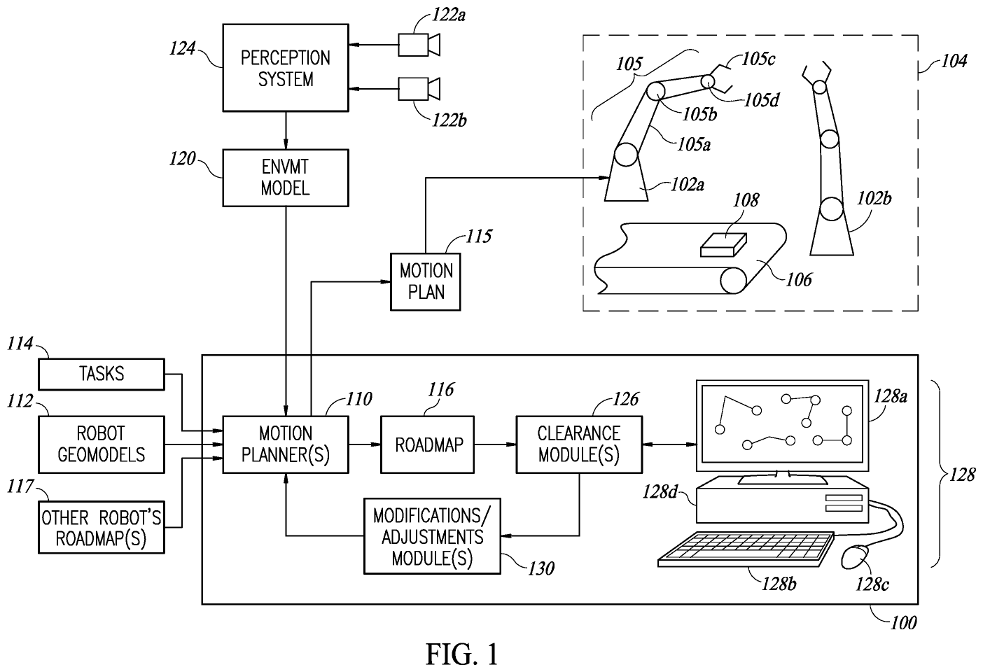

FIG. 1 shows a processor-based system 100 to perform motion planning along with one or more robots 102a, 102b (two shown, collectively 102) that operate in an operational environment 104 (also referred to as a workcell) to carry out tasks, according to one illustrated implementation.

The robots 102 can take any of a large variety of forms. Typically, the robots 102 will take the form of, or have, one or more robotic appendages 105 (only one called out in FIG. 1). The robotic appendages 105 may include one or more linkages with one or more links 105a, one or more joints 105b, with an end effector or end of arm tool 105c, typically located at a tool center point 105d, and optionally one or more cables. The processor-based system 100 may employ other forms of robots 102, for example autonomous vehicles, either with or without moveable appendages.

The operational environment 104 typically represents a three-dimensional space in which the robots 102a, 102b may operate and move, although in certain limited implementations the operational environment 104 may represent a two-dimensional space or area.

The operational environment 104 may include one or more objects in the form of obstacles, for example pieces of machinery (e.g., conveyor 106), posts, pillars, walls, ceiling, floor, tables, humans, and/or animals. It is noted that a robot 102b or portion thereof may constitute an obstacle when considered from a viewpoint of another robot 102a (i.e., when motion planning for robot 102a) in situations where portions of the robots 102a, 102b may overlap in space and time or otherwise collide if motion is not controlled to avoid collision. The operational environment 104 may additionally include one or more objects in the form of work items or work pieces 108 which the robots 102 manipulate as part of performing tasks, for example one or more parcels, packaging, fasteners, tools, items or other objects.

The processor-based system 100 may include one or more motion planners 110. In at least some implementations, a single motion planner 110 may be employed to perform motion planning for two, more, or all robots 102. In other implementations, a respective motion planner 110 is employed to perform motion planning for each of the robots 102a, 102b.

The motion planners 110 are optionally communicatively coupled to control one or more of the robots 102, for example by providing respective motion plans 115 (one shown) to the robots 102 for execution by the robots 102. The motion planners 110 are also communicatively coupled to receive various types of input. For example, the motion planners 110 may receive robot geometric models 112 (also known as kinematic models). Also for example, the motion planners 110 may receive tasks 114. The motion planners 110 may optionally receive other roadmaps 117, where the other roadmaps 117 are roadmaps 117 for other robots 102 operating in the operational environment 104 with respect to a given robot 102 for which a particular instance of motion planning or clearance determination is being performed. For example, with respect to motion planning or clearance determination for a first robot 102a, the second robot 102b would be considered the other robot. When motion planning or performing clearance determination for the second robot 102b, the first robot 102a would be considered the other robot.

The motion planners 110 produce or generate roadmaps 116 based, at least in part, on the received input.

The robot geometric models (GEOMODELS) 112 define a geometry of a given robot 102, for example in terms of joints, degrees of freedom, dimensions (e.g., length of linkages), and/or in terms of the respective “configuration space” or “C-space” of the robot 102. The conversion of robot geometric models 112 to roadmaps (i.e., motion planning graphs) 116 may occur before runtime or task execution, performed for example by a processor-based server system (not illustrated), and provided to the motion planners 110. Alternatively, roadmaps 116 may, for example, be generated by the processor-based system 100 using the robot geometric models 112, using any of a variety of techniques.

The tasks 114 specify tasks to be performed, for example in terms of end poses, end configurations or end states, and/or intermediate poses, intermediate configurations or intermediate states of the respective robot 102. Poses, configurations or states may, for example, be defined in terms of joint positions and joint angles/rotations (e.g., joint poses, joint coordinates) of the respective robot 102.

The motion planners 110 are optionally communicatively coupled to receive input in the form of an environmental model 120, for example provided by a perception system 124. The environmental model 120 is representative of static and/or dynamic objects in the workcell or operational environment 104 that are either known a priori and/or not known a priori. The environmental model 120 may, for example, take the form of a point cloud, an occupancy grid, boxes (e.g., bounding boxes) or other geometric objects, or a stream of voxels (i.e., a “voxel” is an equivalent to a 3D or volumetric pixel) that represents obstacles that are present in the operational environment 104. The environmental model 120 may generated by the perception system 124 from raw data as sensed via one or more sensors 122a, 122b (e.g., two-dimensional or three-dimensional cameras, time-of-flight cameras, laser scanners, LIDAR, LED-based photoelectric sensors, laser-based sensors, a passive infrared (PIR) motion sensors, ultrasonic sensors, sonar sensors).

The perception system 124 may include one or more processors, which may execute one or more machine-readable instructions that cause the perception system 124 to generate a respective discretization of a representation of an operational environment 104 in which the robots 102 will operate to execute tasks for various different scenarios. The perception system 124 may be distinct and separate from, but communicatively coupled to the processor-based system 100. Alternatively, the perception system 124 may form part of the processor-based system 100.

The motion planners 110 are optionally communicatively coupled to receive input in the form of static object data (not shown). The static object data is representative (e.g., size, shape, position, space occupied) of static objects in the operational environment 104, which may, for instance, be known a priori. Static objects may, for example, include one or more of fixed structures in the operational environment 104, for instance posts, pillars, walls, ceiling, floor, conveyor 106.

The motion planners 110 are operable to dynamically generate motion plans 115 to cause the robots 102 to carry out tasks in an operational environment 104, while taking into account objects (e.g., conveyor 106) in the operational environment 104, including other robots 102. As an example, the motion planners 110 take into account collision assessments and determined clearances between the robot 102 or portions thereof and objects (e.g., conveyor 106) in the operational environment 104, including other robots 102. The motion planners 110 may optionally take into account representations of a priori static objects represented by static object data and/or environmental model 120 when producing motion plans 115. Optionally, when motion planning for a given robot (e.g., first robot 120a) the motion planners 110 may take into account a state of motion of other robots 102 (e.g., second robot 102b) at a given time, for instance whether or not another robot 102 (e.g., second robot 102b) has completed a given motion or task, and allowing a recalculation of a motion plan for the given robot (e.g., first robot 102a) based on a motion or task of one of the other robots (e.g., second robot 102b) being completed, thus making available a previously excluded path or trajectory to choose from. Optionally, the motion planners 110 may take into account an operational condition of the robots 102, for instance an occurrence or detection of a failure condition, an occurrence or detection of a blocked state, and/or an occurrence or detection of a request to expedite or alternatively delay or skip a motion-planning request.

The processor-based system 100 may include one or more Clearance Determination and Representation modules 126, for example a respective Clearance Determination and Representation module 126 for each of the robots 102a, 102b respectively. In at least some implementations, a single Clearance Determination and Representation module 126 may be employed to determine clearances for two, more, or all robots 102. As explained herein, the Clearance Determination and Representation modules evaluate motions of a robot 102 or portions thereof, with respect to one or more objects in the operational environment 104, to determine an amount of clearance or margin between the robot 102 or portion thereof and the object(s) during a motion or movement of the robot or portions thereof. Such may be evaluated in addition to, and even as part of performing collision assessment. The Clearance Determination and Representation modules 126 may, for example, simulate motions specified in a roadmap 116, evaluating distances between one or more portions (e.g., links, joints, end of arm tool, tool center point) of the robot 102 and one or more objects in the operational environment 104, including other robots 102 over a range of the motions.

The processor-based system 100 may include one or more presentation systems 128. Alternatively, the presentation systems 128 can be separate and distinct from, but communicatively coupled to the processor-based system 100. The presentation systems 128 includes one or more displays 128a, also referred to as display screens. The presentation systems 128 may include one or more user interface components or devices, for example one or more of a keyboard 128b, keypad, computer mouse 128c, trackball, stylus or other user input component or device. The display 128a may, for example, take the form of a touch screen display, to operate as a user input and output (I/O) component or device. In at least some implementations, the presentation systems 128 may optionally take the form of a computer system 128d (e.g., personal computer system, high performance work station, for instance CAD workstation), for example having its own processor(s), memory and/or storage devices. Alternatively, operation may include presentation via a Web-based interface for instance in a Software as a Service (SaaS) implementation, where the processing is performed remotely from the display 128a.

The processor-based system 100 may include one or more Modifications and/or Adjustment modules 130, for example a respective Modifications and/or Adjustment module 130 for each of the robots 102a, 102b respectively. In at least some implementations, a single Modifications and/or Adjustment module 130 may be employed for two, more, or all robots 102. As explained herein, the Modifications and/or Adjustment modules 130 may make modifications or adjustments to a roadmap based at least in part on the determined clearances and/or based at least in part on input that is in turn based at least in part on the determined clearances. In some instances, modifications or adjustments may be made directly or autonomously (i.e., without user or operator input or other user or operator intervention). For example, Modifications and/or Adjustment modules 130 may automatically and autonomously set or adjust a respective cost metric for one or more edges of a roadmap 116 based on the determined clearances, for instance where a determined clearance fails to satisfy a condition (e.g., less than a specified or nominal clearance). In some instances, modifications or adjustments may be made indirectly with respect to the determined clearances, that is based on user or operator intervention (e.g., user or operator inputs, user or operator selections) which may themselves be based at least in part on user or operator consideration of the indications of determined clearance. For example, Modifications and/or Adjustment modules 130 may add nodes, add edges, delete nodes, delete edges, duplicate or copy nodes, duplicate or copy edges, move nodes, move edges, set or change values of various parameters based on user or operator input or intervention which is itself based on a user assessment of displayed indications of determined clearances.

Various communicative paths are illustrated in FIG. 1 as arrows. The communicative paths may for example take the form of one or more wired communications paths (e.g., electrical conductors, signal buses, or optical fiber) and/or one or more wireless communications paths (e.g., via RF or microwave radios and antennas, infrared transceivers). Each of the motion planners 110 is may optionally be communicatively coupled to one another, either directly or indirectly, to provide the other roadmap(s) 117 to motion planners 110 for robots (e.g., robot 102b) other than the robot (e.g., robot 102a) for which the motion is being planned. For example, the motion planners 110 may be communicatively coupled to one another via a network infrastructure, for instance a non-proprietary network infrastructure (e.g., Ethernet network infrastructure).

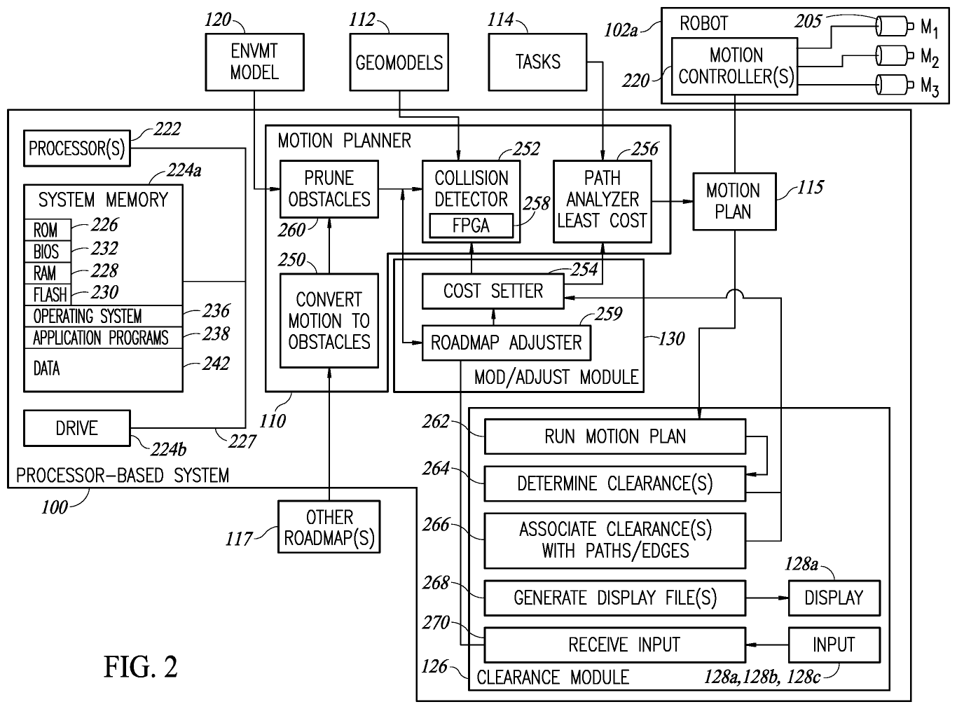

FIG. 2 shows the processor-based system 100 to perform motion planning and the first robot 102a of FIG. 1 in further detail. The processor-based system 100 includes the motion planner 110 that generates motion plans 115 to control operation of the first robot 102a, and optionally may cause adjustments to roadmaps 116 (FIG. 1), for example via the setting of cost metrics. The processor-based system 100 also includes the Clearance Determination and Representation module 126 (labeled “Clearance Module” in FIG. 2) that determines an amount of clearance or margin between the robot 102 or portion thereof and the object(s) during a motion or movement of the robot or portions thereof and causes presentation of visual indications of the determined clearances.

The processor-based system 100 may include other motion planners to generate motion plans and optionally cause adjustment of roadmaps for other robots (not illustrated in FIG. 2), and may include other Clearance Determination and Representation modules 126 to generate determine clearances for other robots and to present visual indications of the determined clearances.

The processor-based system 100 may be communicatively coupled, for example via at least one communications channel (e.g., transmitter, receiver, transceiver, radio, router, Ethernet), to receive roadmaps or motion planning graphs from one or more sources of roadmaps or motion planning graphs. The source(s) of roadmaps or motion planning graphs may be separate and distinct from the motion planner 110, for example, server computers which may be operated or controlled by respective manufacturers of the robots 102 or by some other entity. The roadmaps or motion planning graphs may be determined, set up, or defined prior to a runtime (i.e., defined prior to performance of tasks), for example during a pre-runtime or configuration time. This advantageously permits some of the most computationally intensive work to be performed before runtime, when responsiveness is not a particular concern. The roadmaps or motion planning graphs may be adjusted or updated based at least in part on determined clearances, for example as described herein.

As noted above, each robot 102 may, for example, include a robotic appendage 105 (FIG. 1) that comprises a set of links 105a, joints 105b, end effectors or end of arm tools 105c. The robots 102 may also include one or more actuators 205 (three illustrated and only one called out in FIG. 2) coupled and operable to move the linkages in response to control or drive signals. The actuators 205 may take the form of one or more of: electric motors, stepper motors, solenoids, pneumatic actuators or hydraulic actuators). Pneumatic actuators may, for example, include one or more pistons, cylinders, valves, reservoirs of gas, and/or pressure sources (e.g., compressor, blower). Hydraulic actuators may, for example, include one or more pistons, cylinders, valves, reservoirs of fluid (e.g., low compressibility hydraulic fluid), and/or pressure sources (e.g., compressor, pump).

Each robot 102 may include one or more motion controllers (e.g., motor controllers) 220 (only one shown in FIG. 2) that receive control signals, for instance in the form of motion plans 115, and that provide drive signals to drive the actuators 205.

There may be a processor-based system 100 for each robot 102a, 102b (FIG. 1), or alternatively one processor-based system 100 may perform the motion planning for two or more robots 102a, 102b. One processor-based system 100 will be described in detail with respect to FIG. 2 for illustrative purposes. Those of skill in the art will recognize that the description can be applied to similar or even identical additional instances of processor-based systems 100.

The processor-based system 100 may comprise one or more processor(s) 222, and one or more associated non-transitory computer- or processor-readable storage media for example system memory 224a, drives 224b, and/or memory or registers (not shown) of the processors 222. The non-transitory computer- or processor-readable storage media are communicatively coupled to the processor(s) 222 via one or more communications channels, such as system bus 227. The system bus 227 can employ any known bus structures or architectures, including a memory bus with memory controller, a peripheral bus, and/or a local bus. One or more of such components may also, or instead, be in communication with each other via one or more other communications channels, for example, one or more parallel cables, serial cables, or wireless network channels capable of high speed communications, for instance, Universal Serial Bus (“USB”) 3.0, Peripheral Component Interconnect Express (PCIe) or via Thunderbolt®.

The processor-based system 100 may also be communicably coupled to one or more remote computer systems, e.g., server computer, desktop computer, laptop computer, ultraportable computer, tablet computer, smartphone, wearable computer and/or sensors (not illustrated in FIG. 2). Remote computing systems (e.g., server computer) may be used to program, configure, control or otherwise interface with or input data (e.g., other roadmap(s) 117, specifications of tasks 114) to the processor-based system 100 and various components of the processor-based system 100. Such a connection may be through one or more communications channels, for example, one or more wide area networks (WANs), for instance, Ethernet, or the Internet, using Internet protocols.

As noted, the processor-based system 100 may include one or more processor(s) 222, (i.e., circuitry), non-transitory storage media (e.g., system memory 224a, drive(s) 224b), and system bus 227 that couples various system components. The processors 222 may be any logic processing unit, such as one or more microcontrollers, central processing units (CPUs), digital signal processors (DSPs), graphics processing units (GPUs), field programmable gate arrays (FPGAs), application-specific integrated circuits (ASICs), programmable logic controllers (PLCs), etc. The system memory 224a may include read-only memory (“ROM”) 226, random access memory (“RAM”) 228, FLASH memory 230, and EEPROM (not shown). A basic input/output system (“BIOS”) 232, which can be stored by the ROM 226, contains basic routines that help transfer information between elements within the processor-based system 100, such as during start-up.

The drive 224b may be, for example, a hard disk drive (HDD) for reading from and writing to a magnetic disk, a solid state drive (SSD, e.g., flash memory) for reading from and writing to solid-state memory, and/or an optical disk drive (ODD) for reading from and writing to removable optical disks. The processor-based system 100 may also include any combination of such drives in various different embodiments. The drive 224b may communicate with the processor(s) 222 via the system bus 227. The drive(s) 224b may include interfaces or controllers (not shown) coupled between such drives 224b and the system bus 227. The drives 224b and associated computer-readable media provide nonvolatile storage of computer- or processor readable and/or executable instructions, data structures, program modules and other data for the processor-based system 100. Those skilled in the relevant art will appreciate that other types of computer-readable media that can store data accessible by a computer may be employed, such as WORM drives, RAID drives, magnetic cassettes, digital video disks (“DVD”), Bernoulli cartridges, RAMs, ROMs, smart cards, etc.

Executable instructions and data can be stored in the system memory 224a, for example an operating system 236, one or more application programs 238, and program data 242. Application programs 238 may include processor-executable instructions, logic and/or algorithms that cause the processor(s) 222 to perform one or more of: generating discretized representations of the operational environment 104 (FIG. 1) in which the robot 102 will operate, including objects (e.g., obstacles and/or target objects or work pieces) in the operational environment 104 where planned motions of other robots 102 may be represented as obstacles; generating motion plans 115 including calling for or otherwise obtaining results of a collision assessment, determining clearances between robots 102 or portions thereof and objects (e.g., obstacles, for instance conveyor 106) in the operational environment 104; presenting representations of movement (e.g., roadmaps, representations of paths in three-dimensional space) along with visual indications (e.g., numeric values, colors, heat maps, visual cues or effects) of determined clearances, modifying and/or adjusting roadmaps 116 (FIG. 1) including, for instance setting cost values for edges in a roadmap, evaluating available paths in the roadmap; optionally storing the determined plurality of roadmaps and/or providing the motion plans 115 for execution by the robots 102. The motion planning (e.g., collision detection or assessment), the updating of cost values of edges in roadmaps based on collision detection and/or based on determination or assessment of clearances, can be executed as described herein and in the references incorporated herein by reference. The collision detection or assessment may be performed using various structures and techniques described elsewhere herein. The clearance determination or assessment may be performed using various structures and techniques described elsewhere herein. Application programs 238 may additionally include one or more machine-readable and machine-executable instructions that cause the processor(s) 222 to perform other operations, for instance optionally handling perception data (captured via sensors). Application programs 238 may additionally include one or more machine-executable instructions that cause the processor(s) 222 to perform various other methods described herein and in the references incorporated herein by reference.

While shown in FIG. 2 as being stored in the system memory 224a, the operating system 236, application programs 238, and/or program data 242 can be stored on other non-transitory computer- or processor-readable media, for example drive(s) 224b.

The motion planner 110 of the processor-based system 100 may include dedicated motion planner hardware (e.g., FPGA) or may be implemented, in all or in part, via the processor(s) 222 and processor-executable instructions, logic or algorithms stored in the system memory 224a and/or drive 224b.

The motion planner 110 may include or implement an optional motion converter 250, a collision detector 252, and a path analyzer 256.

The Modifications and/or Adjustment module 130 may include a roadmap adjuster 259 and a cost setter 254.

The motion converter 250 converts motions of other ones of the robots 102 into representations of obstacles, which advantageously allows the motion of other robots (e.g., robot 102b) to be taken into account when assessing collisions and clearances for a given robot (e.g., robot 102a). The motion converter 250 receives the motion plans or other representations of motion, for instance from other motion planners 110. The motion converter 250 then determines an area or volume corresponding to the motion(s). For example, the motion converter 250 can convert the motion to a corresponding swept volume, that is a volume swept by the corresponding robot or portion thereof in moving or transitioning between poses as represented by the motion plan. Advantageously, the motion planner 110 may simply queue the obstacles (e.g., swept volumes), and may not need to determine, track or indicate a time for the corresponding motion or swept volume. While described as a motion converter 250 for a given robot 102 converting the motions of other robots to obstacles, in some implementations the other robots 102b (FIG. 1) may provide the obstacle representation (e.g., swept volume) of a particular motion to the given robot 102.

The collision detector 252 performs collision detection or analysis, determining whether a transition or motion of a given robot 102 or portion thereof will result in a collision with an obstacle. As noted, the motions of other robots 102 may advantageously be represented as obstacles. Thus, the collision detector 252 can determine whether a motion of one robot (e.g., robot 102a) will result in collision with another robot (e.g., robot 102b) that moves through the workcell or operational environment 104 (FIG. 1).

In some implementations, collision detector 252 implements software based collision detection or assessment, for example performing a bounding box-bounding box collision assessment or an assessment based on a hierarchy of geometric (e.g., spheres) representations of the volume swept by the robot(s) 102 or swept by portions of the robot(s) during movement thereof. In some implementations, the collision detector 252 implements hardware based collision detection or assessment, for example employing a set of dedicated hardware logic circuits to represent obstacles and streaming representations of motions through the dedicated hardware logic circuits. In hardware based collision detection or assessment, the collision detector 252 can employ one or more configurable arrays of circuits, for example one or more FPGAs 258, and may optionally produce Boolean collision assessments.

The roadmap adjuster 259 adjusts or modifies a roadmap 116 (FIG. 1), based directly (e.g., autonomously) or indirectly (e.g., based on user or operator input which itself is based on visual indications) on the determined clearances or margins determined by a processor 222. For example, the roadmap adjuster 259 may add one or more nodes to a roadmap 116, remove one or more nodes from a roadmap 116, and/or move one or more nodes in a roadmap 116. Additionally or alternatively, the roadmap adjuster 259 may, for example, add one or more edges to a roadmap 116, remove one or more edges from a roadmap 116, and/or move one or more edges in a roadmap 116. Additionally or alternatively, the roadmap adjuster 259 may, for example, set or otherwise adjust a value of one or more parameters associated with a roadmap 116 or associated with one or more nodes or edges of roadmap 116. For instance, the roadmap adjuster 259 may adjust or otherwise set a speed of movement associated with one or more edges and/or adjust a value of a path smoothing parameter.

The cost setter 254 can set or adjust a cost metric of edges in a roadmap 116 (FIG. 1), based at least in part on the collision detection or assessment by the motion planner 110, and optionally based at least in part on determined clearances determined by the Determine Clearances Module 264. For example, the cost setter 254 can set a relatively high value for the cost metric for edges that represent transitions between states or motions between poses that result or would likely result in collision, and/or that result in or would likely result in an insufficient clearance (e.g., less than a specified or nominal clearance) being maintained between the robot or portion thereof and one or more objects in the operational environment 104 (FIG. 1). Also for example, the cost setter 254 can set a relatively low value for the cost metric for edges that represent transitions between states or motions between poses that do not result or would likely not result in collision and/or which would not likely result in an insufficient clearance (e.g., less than a specified or nominal clearance) being maintained between the robot or portion thereof and one or more objects in the operational environment 104. Setting cost can include setting or adjusting a value of a cost metric that is logically associated with a corresponding edge via some data structure (e.g., field, pointer, table, vector). The cost metric may, for example be determined based on a cost function, with one or more parameters, for instance a collision assessment parameter, a clearance assessment parameter, latency parameter and/or energy expenditure parameter. The parameters may have their own respective weightings in the cost function. For example the collision assessment may be weighted more heavily than the clearance assessment. Also for example, the clearance assessment parameter may be weighted more heavily than the latency parameter and/or the energy expenditure parameter. The cost metrics may be on a scale, for example 0-10, 0-100, 0-1,000, or 0-10,000.

The path analyzer 256 may determine a path (e.g., optimal or optimized) using the roadmap with the cost metrics. For example, the path analyzer 256 may constitute a least cost path optimizer that determines a lowest or relatively low cost path between two states, configurations or poses, the states, configurations or poses which are represented by respective nodes in the roadmap. The path analyzer 256 may use or execute any variety of path finding algorithms, for example lowest cost path finding algorithms, taking into account cost values logically associated with each edge which represent likelihood of collision and/or a likelihood of not maintaining a specified clearance, and optionally other parameters.

Various algorithms and structures to determine the least cost path may be used, including those that implement the Bellman-Ford algorithm, but others may be used, including, but not limited to, any such process in which the least cost path is determined as the path between two nodes in the roadmap 116 such that the sum of the cost metrics or weights of its constituent edges is minimized. This process improves the technology of motion planning for a robot 102 by using a roadmap 116 which represents collision assessment as well as clearance determinations or assessments for the motions of the robot to increase the efficiency and response time to find the “best” path to perform a task without collisions while maintaining specified or nominal clearances.

The motion planner 110 may optionally include a pruner 260. The pruner 260 may receive information that represents completion of motions by other robots, the information denominated as motion completed messages. Alternatively, a flag could be set to indicate completion. In response, the pruner 260 may remove an obstacle or portion of an obstacle that represents a now completed motion. That may allow generation of a new motion plan for a given robot (e.g., robot 102a), which may be more efficient or allow the given robot to attend to performing a task that was otherwise previously prevented by the motion of another robot (e.g., robot 102b). This approach advantageously allows the motion converter 250 to ignore timing of motions when generating obstacle representations for motions, while still realizing better throughput than using other techniques. The motion planner 110 may additionally cause the collision detector 252 to perform a new collision detection or assessment and clearance determination or assessment given the modification of the obstacles to produce an updated roadmap 116 in which the edge weights or costs associated with edges have been modified, and to cause the cost setter 254 and path analyzer 256 to update cost metrics and determine a new or revised motion plan accordingly.

The motion planner 110 may optionally include an environment converter (not shown) that converts output (e.g., digitized representations of the environment) from optional sensors (e.g., digital cameras, not shown) into representations of obstacles. Thus, the motion planner 110 can perform motion planning that takes into account transitory objects in the operational environment 104 (FIG. 1), for instance people, animals, etc.

The Clearance Determination and Representation module 126 evaluates motions of a robot 102 or portions thereof with respect to one or more objects in the operational environment 104 to determine an amount of clearance or margin between the robot 102 or portion thereof and the object(s) during a motion or movement of the robot or portions thereof. To do so, the Clearance Determination and Representation module 126 may employ a Run Motion module 262 that simulates or actually executes motions specified by a roadmap 116 or portion thereof (e.g., an edge) of one or more robots (e.g., robot 102a, FIG. 1). The Clearance Determination and Representation module 126 may include a Determine Clearances module 264 to determine clearances or margins of one or more portions of the robot 102 (e.g., robot 102a) with respect to objects in the operational environment 104, including other robots (e.g., robot 102b, FIG. 1) as the motion is simulated or actually executed.

Various approaches may be employed to determine clearances, for example approaches employing posed meshes or sphere trees, or alternatively swept volumes. In some implementations, clearance detection is for offline use, including roadmap construction, roadmap adjustment, and/or visualization. Since it is not typically possible to plan for dynamic objects ahead of time, clearance detection is typically employed for static objects. Where clearance detection is being employed for offline use (e.g., roadmap construction, roadmap adjustment, and/or visualization), the approach employed does not need to be as fast as if used in an online application (e.g., controlling a robot in real time).

There are at least two approaches of performing clearance detection. One approach is to use meshes of polygons with software that is either custom or based on publically available software (e.g., the flexible collision library or FCL). Provided with a set of meshes (e.g., meshes of triangles), the software will determine distances between the meshes. This approach is general in nature, and is not particular to robots. When employing this approach, the system would cover obstacles in the operational environment in meshes. The system may additionally cover a swept volume of each motion of a robot with a mesh. It may be easier under this approach to break up a motion of a robot into a number of intermediate poses, where the number is chosen, for example, to meet a threshold for a difference between joint angles in consecutive poses. The system would then wrap each pose with a respective mesh. In another approach, the system employs data structures, similar in at least some respects to the data structures employed in collision detection described in various ones of Applicant's own filed patent applications. For example, the system may represent the obstacles present in the operational environment with a distance field (e.g., Euclidean distance field), and represent the poses of a robot a sphere tree. It is relatively simple for the system to calculate a distance from a sphere tree to anything in a distance field.

The Clearance Determination and Representation module 126 also includes an Associate Clearances With Paths Or Edges module 266 that logically associates determined clearances with respective paths or edges, for example in a data structure stored in memory or some other processor-readable media. In some implementations, the Determine Clearances module 264 or the Associate Clearances With Paths Or Edges module 266 may be communicatively coupled directly to the cost setter 254 so that the cost setter 254 may automatically and autonomously (i.e., without user or operator input or other user, operator or human intervention) set or adjust cost metrics associated with edges based on the determined clearances.

The Clearance Determination and Representation module 126 causes representations of movement or motion to be presented, for example in the form of three-dimensional representations that illustrate movement or motion of a robot or portion thereof as paths in the three-dimensional space of the operational environment, or in the form of roadmaps that illustrate motions as edges that represent transitions between configurations or poses of the robot in the C-space of the robot. The Clearance Determination and Representation module 126 further causes visual indications of the determined clearances to be presented in the representations of movement or motion, for example as numeric values, colors, heat maps, and/or cues or visual effects. For example, the Clearance Determination and Representation module 126 may include a Generate Display File(s) module 268, which generates display files, which when displayed include a representation of the motions and visual indications of determined clearances. The Generate Display File(s) module 268 may generate display files for the representation of motion separately from display files for the indications of determined clearance. Alternatively, the Generate Display File(s) module 268 may generate display files that combine both the representation of motion and the indications of determined clearance.

Optionally, the Clearance Determination and Representation module 126 includes a Receive Input module 270 that receives input from one or more input devices (e.g., touch screen display 128a, keyboard 128b, computer mouse 128c). Based on the received input, the Receive Input module 270 may provide instructions, commands and/or data to the roadmap adjuster 259 and/or cost setter 254.

The processor(s) 222 and/or the motion planner 110 may be, or may include, any logic processing units, such as one or more central processing units (CPUs), digital signal processors (DSPs), graphics processing units (GPUs), application-specific integrated circuits (ASICs), field programmable gate arrays (FPGAs), programmable logic controllers (PLCs), etc. Non-limiting examples of commercially available computer systems include, but are not limited to, the Celeron, Core, Core 2, Itanium, and Xeon families of microprocessors offered by Intel® Corporation, U.S.A.; the K8, K10, Bulldozer, and Bobcat series microprocessors offered by Advanced Micro Devices, U.S.A.; the A5, A6, and A7 series microprocessors offered by Apple Computer, U.S.A.; the Snapdragon series microprocessors offered by Qualcomm, Inc., U.S.A.; and the SPARC series microprocessors offered by Oracle Corp., U.S.A. The construction and operation of the various structure shown in FIG. 2 may implement or employ structures, techniques and algorithms described in or similar to those described in International Patent Application No. PCT/US2017/036880, filed Jun. 9, 2017 entitled “MOTION PLANNING FOR AUTONOMOUS VEHICLES AND RECONFIGURABLE MOTION PLANNING PROCESSORS”; International Patent Application Publication No. WO 2016/122840, filed Jan. 5, 2016, entitled “SPECIALIZED ROBOT MOTION PLANNING HARDWARE AND METHODS OF MAKING AND USING SAME”; U.S. Patent Application No. 62/616,783, filed Jan. 12, 2018, entitled, “APPARATUS, METHOD AND ARTICLE TO FACILITATE MOTION PLANNING OF AN AUTONOMOUS VEHICLE IN AN ENVIRONMENT HAVING DYNAMIC OBJECTS”; and/or U.S. 63/105,542, filed Oct. 26, 2020, as suitably modified to operate as described herein.

Although not required, many of the implementations will be described in the general context of computer-executable instructions, such as program application modules, objects, or macros stored on computer- or processor-readable media and executed by one or more computer or processors that can perform obstacle representation, collision assessments, clearance determinations, and other motion planning operations.

Motion planning operations may include, but are not limited to, generating or transforming one, more or all of: a representation of the robot geometry based on a robot geometric model 112 (FIG. 1), tasks 114 (FIG. 1), roadmaps 116, and the representation of volumes (e.g. swept volumes) occupied by robots in various states or poses and/or during movement between states or poses into digital forms, e.g., point clouds, Euclidean distance fields, data structure formats (e.g., hierarchical formats, non-hierarchical formats), and/or curves (e.g., polynomial or spline representations). Motion planning operations may optionally include, but are not limited to, generating or transforming one, more or all of: a representation of the static or persistent obstacles represented by static object data and/or the environmental model 120 (FIG. 1) representative of static or transient obstacles into digital forms, e.g., point clouds, Euclidean distance fields, data structure formats (e.g., hierarchical formats, non-hierarchical formats), and/or curves (e.g., polynomial or spline representations).

Motion planning operations may include, but are not limited to, determining or detecting or predicting collisions for various states or poses of the robot or motions of the robot between states or poses using various collision assessment techniques or algorithms (e.g., software based, hardware based). Motion planning operations may include, but are not limited to, determining or detecting clearances between a robot or portions thereof and one or more objects in the operational environment experienced by the robot or portions thereof in executing the motions, presenting the determined clearances, and generating or revising roadmaps based at least in part on the determined clearances.

In some implementations, motion planning operations may include, but are not limited to, determining one or more motion plans; storing the determined motion plan(s); and/or providing the motion plan(s) to control operation of a robot.

In one implementation, collision detection or assessment is performed in response to a function call or similar process. The collision detector 252 may be implemented via one or more field programmable gate arrays (FPGAs) 258 and/or one or more application specific integrated circuits (ASICs) to perform the collision detection while achieving low latency, relatively low power consumption, and increasing an amount of information that can be handled.

In various implementations, such operations may be performed entirely in hardware circuitry or as software stored in a memory storage, such as system memory 224a, and executed by one or more hardware processors 222, such as one or more microprocessors, digital signal processors (DSPs), field programmable gate arrays (FPGAs), application specific integrated circuits (ASICs), graphics processing units (GPUs) processors, programmed logic controllers (PLCs), electrically programmable read only memories (EEPROMs), or as a combination of hardware circuitry and software stored in the memory storage.

Various aspects of perception, roadmap construction, collision detection, and path search that may be employed in whole or in part are also described in International Patent Application No. PCT/US2017/036880, filed Jun. 9, 2017 entitled “MOTION PLANNING FOR AUTONOMOUS VEHICLES AND RECONFIGURABLE MOTION PLANNING PROCESSORS,” International Patent Application Publication No. WO 2016/122840, filed Jan. 5, 2016, entitled “SPECIALIZED ROBOT MOTION PLANNING HARDWARE AND METHODS OF MAKING AND USING SAME”; U.S. Patent Application No. 62/616,783, filed Jan. 12, 2018, entitled, “APPARATUS, METHOD AND ARTICLE TO FACILITATE MOTION PLANNING OF AN AUTONOMOUS VEHICLE IN AN ENVIRONMENT HAVING DYNAMIC OBJECTS”; U.S. Patent Application No. 62/856,548, filed Jun. 3, 2019, entitled “APPARATUS, METHODS AND ARTICLES TO FACILITATE MOTION PLANNING IN ENVIRONMENTS HAVING DYNAMIC OBSTACLES”; and/or U.S. 63/105,542, filed Oct. 26, 2020, as suitably modified to operate as described herein. Those skilled in the relevant art will appreciate that the illustrated implementations, as well as other implementations, can be practiced with other system structures and arrangements and/or other computing system structures and arrangements, including those of robots, hand-held devices, multiprocessor systems, microprocessor-based or programmable consumer electronics, personal computers (“PCs”), networked PCs, mini computers, mainframe computers, and the like. The implementations or embodiments or portions thereof (e.g., at configuration time and runtime) can be practiced in distributed computing environments where tasks or modules are performed by remote processing devices, which are linked through a communications network. In a distributed computing environment, program modules may be located in both local and remote memory storage devices or media. However, where and how certain types of information are stored is important to help improve motion planning.

For example, various motion planning solutions “bake in” a roadmap 116 (i.e., a motion planning graph) into a processor (e.g., FPGA 258), and each edge in the roadmap 116 corresponds to a non-reconfigurable Boolean circuit of the processor. The design in which the roadmap 116 is “baked in” to the processor, poses a problem of having limited processor circuitry to store multiple or large roadmaps and is generally not reconfigurable for use with different robots.

One solution provides a reconfigurable design that places the roadmap 116 information into memory storage. This approach stores information in memory instead of being baked into a circuit. Another approach employs templated reconfigurable circuits in lieu of memory.

As noted above, some of the information (e.g., robot geometric models 112) may be captured, received, input or provided during a configuration time that is before runtime. The received information may be processed during the configuration time, including performing collision detection for each edge of a roadmap, to produce processed information (e.g., volumes of space swept by the robot in executing the motions represented as edges in the roadmap) for later use at runtime in order to speed up operation or reduce computation complexity during runtime.

During the runtime, collision detection may be performed for the entire operational environment 104 (FIG. 1), including determining, for any pose or movement between poses, whether any portion of the robot 102 will collide or is predicted to collide with another portion of the robot 102 itself, with other robots 102 or portions thereof, with persistent or static obstacles in the operational environment 104, or with transient obstacles in the operational environment 104 with unknown trajectories (e.g., people or humans).

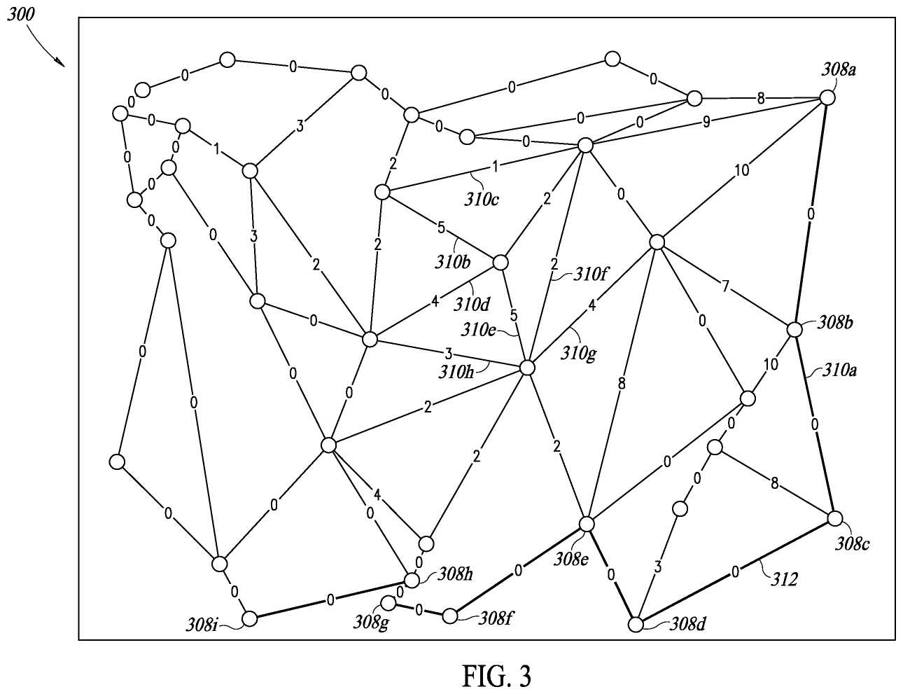

FIG. 3 shows an example roadmap 300 for one of the robots 102a (FIG. 1), in the case where the goal of the robot 102a is to perform a task while avoiding collisions with objects, the objects which can include other robots (e.g., robot 102b) operating in the operational environment 104 (FIG. 1).

The roadmap 300 respectively comprises a plurality of nodes 308a-308i (represented in the drawing as open circles) connected by edges 310a-310h, (represented in the drawing as straight lines between pairs of nodes). Each node represents, implicitly or explicitly, time and variables that characterize a state of the robot 102 in the configuration space of the robot 102. The configuration space is often called C-space and is the space of the states or configurations or poses of the robot 102a represented in the roadmap 300. For example, each node may represent the state, configuration or pose of the robot 102a that may include, but is not limited to, a position, orientation or a combination of position and orientation. The state, configuration or pose may, for example, be represented by a set of joint positions and joint angles/rotations (e.g., joint poses, joint coordinates) for the joints of the robot 102a.

The edges in the roadmap 300 represent valid or allowed transitions between these states, configurations or poses of the robot 102a. The edges of roadmap 300 do not represent actual movements in Cartesian coordinates, but rather represent transitions between states, configurations or poses in C-space. Each edge of roadmap 300 represents a transition of a robot 102a between a respective pair of nodes. For example, edge 310a represents a transition of a robot 102a, between two nodes. In particular, edge 310a represents a transition between a state of the robot 102a in a particular configuration associated with node 308b and a state of the robot 102a in a particular configuration associated with node 308c. Although the nodes are shown at various distances from each other, this is for illustrative purposes only and this is no relation to any physical distance. There is no limitation on the number of nodes or edges in the roadmap 300, however, the more nodes and edges that are used in the roadmap 300, the more accurately and precisely the motion planner 110 (FIGS. 1 and 2) may be able to determine the optimal path according to one or more states, configurations or poses of the robot 102a to carry out a task since there are more paths from which to select the least cost path.

Each edge is assigned or associated with a cost metric which assignment may, for example, be updated at or during runtime. The cost metrics are represented in FIG. 3 as single digit values inserted into respective edges. While illustrated as single digit values, the cost metrics may take a variety of forms including single or multiple digit integers, real numbers, etc. The cost metric may represent a number of different parameters. For example, the cost metric may represent a collision assessment with respect to a motion that is represented by the corresponding edge. Also for example, the cost metric may represent respective clearance determinations. For instance, the cost metric may represent an assessment of a potential or probability of a motion causing a portion of a robot to come within one or more specified or nominal clearance distances of an object in the operational environment. The cost metrics (e.g., weights) assigned to edges may be increased for those edges corresponding to the transitions that result in relatively small clearances and/or that result in clearances below some specified or nominal clearance for one or more portions of the robot. As noted elsewhere, different portions of the robot may be associated with different respective specified or nominal clearances. For example, it may be desirable to maintain a larger clearance for a weld head than for a joint of the robot.

Examples of collision assessment are described in International Patent Application No. PCT/US2017/036880, filed Jun. 9, 2017 entitled “MOTION PLANNING FOR AUTONOMOUS VEHICLES AND RECONFIGURABLE MOTION PLANNING PROCESSORS”; U.S. Patent Application 62/722,067, filed Aug. 23, 2018 entitled “COLLISION DETECTION USEFUL IN MOTION PLANNING FOR ROBOTICS”; and in International Patent Application Publication No. WO 2016/122840, filed Jan. 5, 2016, entitled “SPECIALIZED ROBOT MOTION PLANNING HARDWARE AND METHODS OF MAKING AND USING SAME.”

For nodes in the roadmap 300 where there is a relatively high probability that direct transition between the nodes will cause a collision with an obstacle and/or a relatively high probability of experiencing a small clearance or a clearance less than a specified or nominal clearance, a cost metric or weight assigned to the edges of the roadmap 300 transitioning between those nodes may be assigned a relatively high cost metric (e.g., 8, 9 or 10 out of 10). Conversely, for nodes in the roadmap 300 where there is a relatively low probability that direct transition between the nodes will cause a collision with an obstacle and/or a relatively low probability of experiencing a small clearance or clearance less than a specified or nominal clearance, a cost metric or weight assigned to the edges of the roadmap 300 transitioning between those nodes may be assigned a relatively low cost metric (e.g., 0, 1 or 2 out of 10. For nodes in the roadmap 300 where there is an intermediate probability that direct transition between the nodes will cause a collision with an obstacle and/or an intermediate probability of experiencing a small clearance or clearance less than a specified or nominal clearance, a cost metric or weight assigned to the edges of the roadmap 300 transitioning between those nodes may be assigned a relatively neutral cost metric, neither high nor low (e.g., 4, 5, or 6 out of 10).

As explained above, cost may reflect not only probability of collision, and/or the probability of experiencing low clearance situations, but also other factors or parameters (e.g., latency, energy consumption). In the present example, a current state, configuration or pose of the robot 102 in the roadmap 300 is at node 308a, and the path is depicted as path 312 (bolded line path comprising segments extending from node 308a through node 308i) in the roadmap 300 which is the result of a least cost analysis.

Although shown as a path in roadmap 300 with many sharp turns, such turns do not represent corresponding physical turns in a route, but logical transitions between states, configurations or poses of the robot 102. For example, each edge in the identified path 312 may represent a state change with respect to physical configuration of the robot 102, but not necessarily a change in direction of the robot 102 corresponding to the angles of the path 312 shown in FIG. 3.

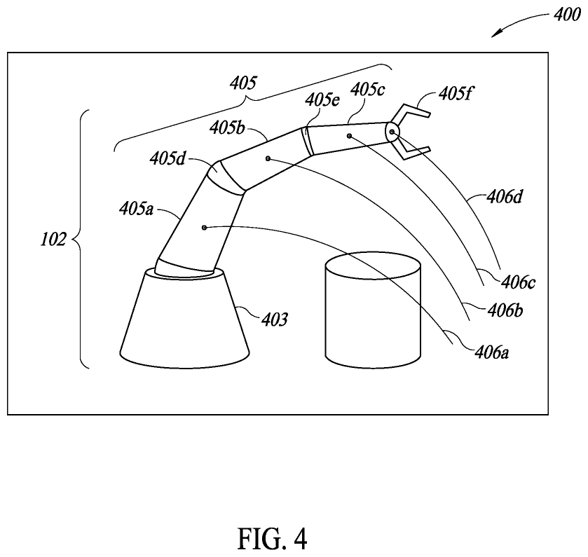

FIG. 4 shows a representation of movement in a three-dimensional environment 400 in which a robot 102 operates.

The robot 102 may include a base 403 and a robotic appendage 405. The robotic appendage 405 includes a plurality of links 405a, 405b, 405c (three shown), a plurality of joints 405d, 405e that rotational couple respective pairs of the links 405a, 405b, 405c, and an end effector or end of arm tool 405f located at a distal end of the robotic appendage 405. The robot 102 includes one or more actuators, for example electric motor 205 (FIG. 2).

The representation of a three-dimensional environment 400 shows a number of paths (four shown) 406a, 406b, 406d, 406d (four shown) that represent the movement or trajectory of respective portions (e.g., links 405a, 405b, 405c, end of arm tool 405f) of the robot 102 in executing a transition between configurations or poses.

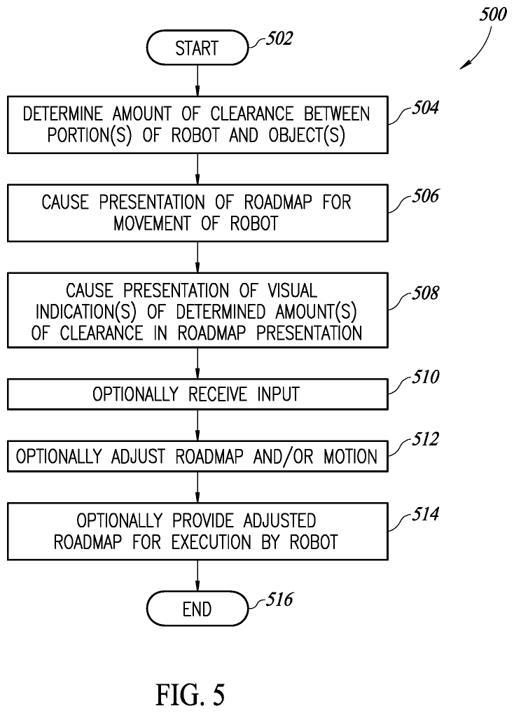

FIG. 5 shows a method 500 of operation in a processor-based system 100 of FIGS. 1 and 2 to determine clearances for one or more portions of a robot, and to cause a presentation of a representation of movement of the one or more portions of the robot as a roadmap along with visual indications of the determined clearances for the one or more portions of the robot, according to at least one illustrated implementation. The method 500 may, for example, be executed by one or more processors 222 (FIG. 2) of a processor-based system 100 (FIG. 1).

The method 500 starts at 502. For example, the method 500 may start in response to a powering ON of a processor-based system 100, a robot control system and/or a robot 102, or in response to a call or invocation from a calling routine. The method 500 may execute continually or even continuously, for example during operation of robot 102.

At 504, a component of the processor-based system 100, for example a Clearance Determination and Representation module 126 or Determine Clearances module 264 (FIG. 2), determines an amount of clearance between one or more portions of the robot and one or more objects in the operational environment. For example, for each movement of the robot, and for each of one, two, or more portions of the robot, the Clearance Determination and Representation module 126 or Determine Clearances module 264 (FIG. 2) computationally determines a respective amount of clearance between the portion(s) of the robot and the one or more objects in an operational environment experienced by the robot or portion thereof in traversing along a path or trajectory of the robot or portion thereof. The determined clearance may, for example, be represented as distances in Cartesian coordinates or as a vector value.

At 506, a component of the processor-based system 100, for example a Clearance Determination and Representation module 126 or a Generate Display File(s) module 268 (FIG. 2), causes a presentation of a representation of one or more movements of the robot. For example, the Clearance Determination and Representation module 126 may cause presentation of a roadmap having a plurality of nodes and a plurality of edges, each edge coupling the nodes of a respective pair of nodes. For instance, the Generate Display File(s) module 268 (FIG. 2) may generate and provide one or more display files to a display system 128. The nodes represent respective configurations of the robot, and the edges represent a respective transition between a respective pair of the configurations of the robot represented by the nodes of the pair of nodes coupled by the respective edge. The transitions correspond to movements of the robot or portions thereof.

At 508, a component of the processor-based system 100, for example a Clearance Determination and Representation module 126 or a Generate Display File(s) module 268 (FIG. 2), causes a presentation of one or more visual indications of the determined clearances in presentation of the movements of the robot, for instance in the presentation of the roadmap. For example, the Clearance Determination and Representation module 126 may, for at least one or more of the portions of the robot, cause a presentation of a visual indication of a respective amount of clearance between the portion of the robot and one or more objects in the environment. For instance, the Generate Display File(s) module 268 (FIG. 2) may generate and provide one or more display files to a display system 128. The indications of determined clearance may take a variety of forms, for example numerical values, colors, heat maps, and/or visual cues or visual effects. The indications of determined clearance may be spatially associated with respective representations of motion, for example spatially associated with respective edges that represent the transitions that correspond to the motions. In implementations, the Generate Display File(s) module 268 may generate separate image files for the roadmap and for the visual indications of determined clearances. The separate images files may, for example be displayed on separate layers of a visual presentation. In other implementations, the Generate Display File(s) module 268 may generate a unified image file that includes both the roadmap and the visual indications of determined clearances in a single image file.

Optionally at 510, a component of the processor-based system 100, for example a Clearance Determination and Representation module 126 or Receive Input module 270 (FIG. 2), receives input. Input may take a variety of forms, for example instructions or commands to add nodes and/or edges to a roadmap, delete nodes and/or edges from the roadmap, move nodes and/or edges in the roadmap, and/or to set, change or adjust a value of one or more parameters (e.g., speed of movement, path smoothing parameter, cost metric of edge). The Clearance Determination and Representation module 126 may receive input from one or more user input/output devices (e.g., touch screen display 128a).

Optionally at 512, a component of the processor-based system 100, for example a roadmap adjuster 259, adjusts the roadmap for the robot based at least in part on the determined clearances. Such may, for example, occur autonomously in response to an occurrence of certain defined conditions. Such may, for example, occur in response to received user or operator input, which itself may be based at least in part on the determined clearances. The roadmap adjuster 259 may adjust one or more components of a data structure in which the roadmap 116 (FIGS. 1 and 2) is represented in memory or other processor-readable storage.

Optionally at 514, a component of the processor-based system 100 provides the motion plan 115 (FIGS. 1 and 2) for execution by the robot. For example, a motion planner 110 may provide a motion plan to the robot or a robot controller for execution by the robot.

The method 500 terminates at 516, for example until invoked again. In some implementations, the method 500 may operate continually or even periodically, for example while the robot or portion thereof is powered.

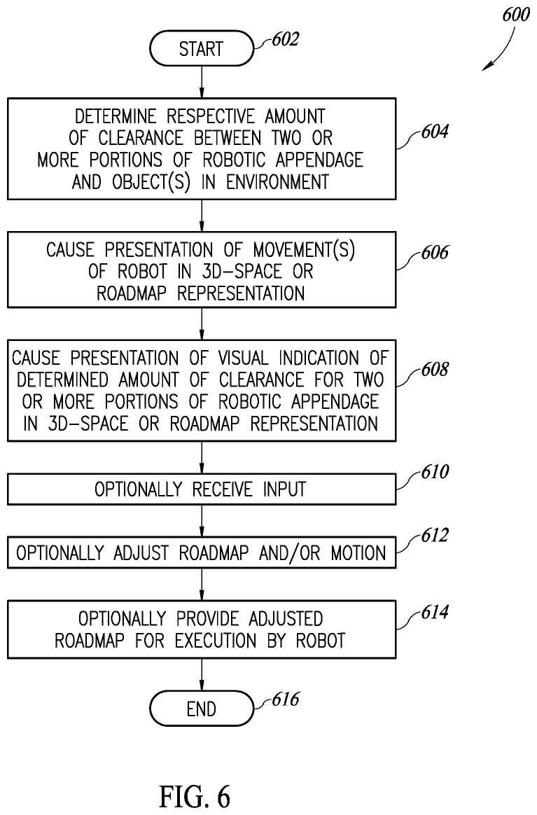

FIG. 6 shows a method 600 of operation in a processor-based system 100 of FIGS. 1 and 2 to determine clearances for at least two or more portions of a robotic appendage that operates in an operational environment, and to cause a presentation of a representation of movement of the two or more portions as paths in a representation of a three-dimensional space in which the robotic appendage operates or as a roadmap, along with visual indications of the determined clearances for the two or more portions of the robotic appendage, according to at least one illustrated implementation. The method 600 may, for example, be executed by one or more processors 222 (FIG. 2) of a processor-based system 100 (FIG. 1).

The method 600 starts at 602. For example, the method 600 may start in response to a powering ON of a processor-based system 100, a robot control system and/or a robot 102, or in response to a call or invocation from a calling routine. The method 600 may execute continually or even continuously, for example during operation of one or more robots 102.

At 604, a component of the processor-based system 100, for example a Clearance Determination and Representation module 126 or Determine Clearances module 264 (FIG. 2), determines an amount of clearance between two or more portions of a robotic appendage and one or more objects in the operational environment. For example, for each movement of the robotic appendage, and for each of at least two or more portions of the robotic appendage, the Clearance Determination and Representation module 126 or Determine Clearances module 264 (FIG. 2) computationally determines a respective amount of clearance between the portion of the robotic appendage and one or more objects in an operational environment experienced by the robotic appendage or portions thereof in traversing along a path or trajectory of the two or more portions of the robotic appendage. The determined clearance may, for example, be represented as distances in Cartesian coordinates or as a vector value.

At 606, a component of the processor-based system 100, for example a Clearance Determination and Representation module 126 or a Generate Display File(s) module 268 (FIG. 2), causes a presentation of a representation of one or more movements of the robotic appendage or the two or more portions thereof. For example, the Clearance Determination and Representation module 126 may cause presentation of one or more paths in a representation of the three-dimensional space in which the robotic appendage operates. Alternatively, the Clearance Determination and Representation module 126 may cause presentation of a roadmap having a plurality of nodes and a plurality of edges, each edge coupling the nodes of a respective pair of nodes. For instance, the Generate Display File(s) module 268 (FIG. 2) may generate and provide one or more display files to a display system 128. In the presentation of one or more paths in a representation of the three-dimensional space, the paths represent movements or trajectories of the robotic appendage or the portions thereof. In the presentation of the roadmap, the nodes represent respective configurations of the robot, and the edges represent a respective transition between a respective pair of the configurations of the robot represented by the nodes of the pair of nodes coupled by the respective edge. The transitions correspond to movements of the robotic appendage or the portions thereof.

At 608, a component of the processor-based system 100, for example a Clearance Determination and Representation module 126 or a Generate Display File(s) module 268 (FIG. 2), causes a presentation of one or more visual indications of the determined clearances in presentation of the movements of the robotic appendage or portions thereof. For example, the Clearance Determination and Representation module 126 may cause presentation of the visual indications in the presentation of the roadmap. Also for example, the Clearance Determination and Representation module 126 may cause presentation of the visual indications in the presentation of the representation of the three-dimensional space in which the robotic appendage operates. The Clearance Determination and Representation module 126 may, for example, for at least two or more of the portions of the robotic appendage, cause a presentation of a visual indication of a respective amount of clearance between the portion of the robotic appendage and one or more objects in the environment. The indications of determined clearance may take a variety of forms, for example numerical values, colors, heat maps, and/or visual cues or effects. The indications of determined clearance may be spatially associated with respective representations of motion, for example spatially associated with respective edges that represent the transitions that correspond to the motions of the portions of the robotic appendage. The Clearance Determination and Representation module 126 or the Generate Display File(s) module 268 (FIG. 2) may generate image files and provide the image files for presentation. In implementations, the Clearance Determination and Representation module 126 or the Generate Display File(s) module 268 (FIG. 2) may generate separate image files for the roadmap and for the visual indications of determined clearances. The separate images files may, for example be displayed on separate layers of a visual presentation. In other implementations, the Clearance Determination and Representation module 126 or the Generate Display File(s) module 268 (FIG. 2) may generate a unified image file that includes both the roadmap and the visual indications of determined clearances.

Optionally at 610, a component of the processor-based system 100, for example a Clearance Determination and Representation module 126 or Receive Input module 270 (FIG. 2), receives input. Input may take a variety of forms, for example instructions or commands to add nodes and/or edges to a roadmap, delete nodes and/or edges from the roadmap, move nodes and/or edges in the roadmap, and/or to set, change or adjust a value of one or more parameters (e.g., speed of movement, path smoothing parameter, cost metric of edge). The Clearance Determination and Representation module 126 or Receive Input module 270 (FIG. 2) may receive input from one or more user input/output devices (e.g., touch screen display 128a).

Optionally at 612, a component of the processor-based system 100, for example a roadmap adjuster 259, adjusts the roadmap 116 for the robotic appendage based at least in part on the determined clearances. Such may, for example, occur autonomously in response to an occurrence of certain defined conditions. Such may, for example, occur in response to received user or operator input, which itself may be based at least in part of the determined clearances. The roadmap adjuster 259 may adjust one or more components of a data structure in which the roadmap 116 is represented in memory or other processor-readable storage.

Optionally at 614, a component of the processor-based system 100 provides the motion plan 115 (FIGS. 1 and 2) for execution by the robotic appendage. For example, a motion planner 110 may provide a motion plan to the robotic appendage or a robot controller for execution by the robotic appendage.

The method 600 terminates at 616, for example until invoked again. In some implementations, the method 600 may operate continually or even periodically, for example while the robotic appendage or portion thereof is powered.

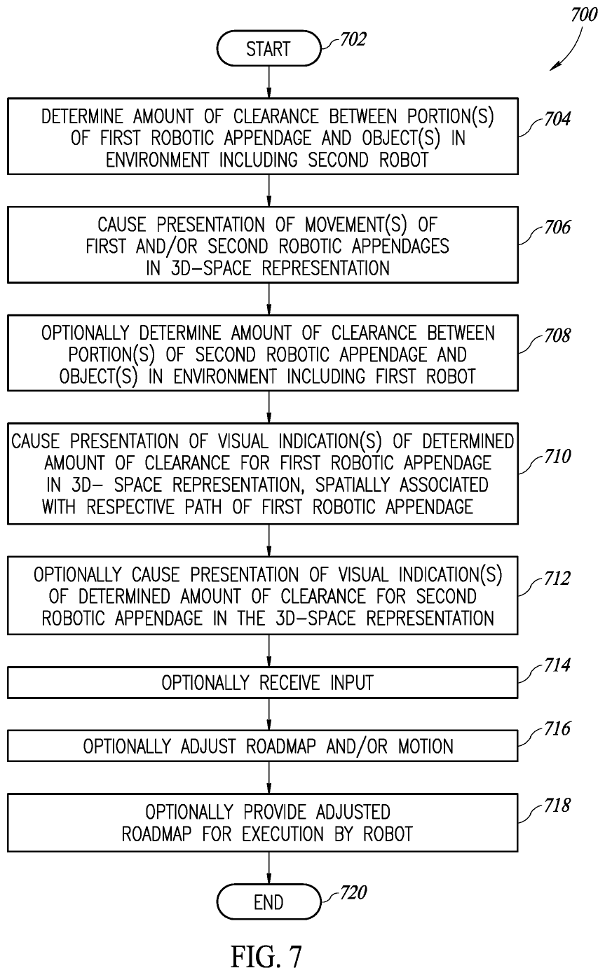

FIG. 7 shows a method 700 of operation in a processor-based system 100 of FIGS. 1 and 2 to determine clearances for one or more portions of at least one of two or more robotic appendages that operate in an operational environment, and to present a representation of movement of at least one of the robotic appendages or portions thereof along with visual indications of the determined clearances for one or more portions of at least one of the robotic appendages, according to at least one illustrated implementation. For example, the operational environment may include a first robot, where the first robot is or includes a first robotic appendage. The operational environment may also include a second robot, where the second robot is or includes a second robotic appendage. The method 700 may, for example, be executed by one or more processors 222 (FIG. 2) of a processor-based system 100 (FIG. 1).

The method 700 starts at 702. For example, the method 700 may start in response to a powering ON of a processor-based system 100, a robot control system and/or robot 102, or in response to a call or invocation from a calling routine. The method 700 may execute continually or even continuously, for example during operation of one or more robotic appendages 105.

At 704, a component of the processor-based system 100, for example a Clearance Determination and Representation module 126 or Determine Clearances module 264 (FIG. 2) determines an amount of clearance between one or more portions of a first robotic appendage and one or more objects in the operational environment. For example, for each movement of the first robotic appendage, and for each of at least one or more portions of the first robotic appendage, the Clearance Determination and Representation module 126 Determine Clearances module 264 (FIG. 2) determines a respective amount of clearance between the portion of the first robotic appendage and one or more objects in an operational environment 104 (FIG. 1) experienced by the first robotic appendage or portions thereof in traversing along a path or trajectory of the first robotic appendage or portions thereof. Notably, the objects may include the second robotic appendage.

At 706, a component of the processor-based system 100, for example a Clearance Determination and Representation module 126 or a Generate Display File(s) module 268 (FIG. 2), causes a presentation of a representation of one or more movements of the first robotic appendage or portions thereof and optionally of the second robotic appendage or portions thereof. For example, the Clearance Determination and Representation module 126 may cause presentation of one or more paths in a representation of the three-dimensional space in which the first robotic appendage and the second robotic appendage operate. The paths represent movements or trajectories of the first robotic appendage or the portions thereof, and optionally of the second robotic appendage or the portions thereof. Alternatively, the Clearance Determination and Representation module 126 may cause presentation of a roadmap having a plurality of nodes and a plurality of edges, each edge coupling the nodes of a respective pair of nodes, which may be particularly suited when representing movements of only one of the first robotic appendage or the second robotic appendage. For instance, the Generate Display File(s) module 268 (FIG. 2) may generate and provide one or more display files to a display system 128.

Optionally at 708, a component of the processor-based system 100, for example a Clearance Determination and Representation module 126 or Determine Clearances module 264 (FIG. 2), determines an amount of clearance between the portions of the second robotic appendage and one or more objects in the operational environment. For example, for each movement of the second robotic appendage, and for each of at least one or more portions of the second robotic appendage, the Clearance Determination and Representation module 126 or Determine Clearances module 264 (FIG. 2) determines a respective amount of clearance between the portion of the second robotic appendage and one or more objects in an operational environment experienced by the second robotic appendage or portions thereof in traversing along a path or trajectory of the second robotic appendage or portions thereof. Notably, the objects may include the first robotic appendage.

At 710, a component of the processor-based system 100, for example a Clearance Determination and Representation module 126 or Generate Display File(s) module 268, causes a presentation of one or more visual indications of the determined clearances in presentation of the movements of at least the first robotic appendage. For example, the Clearance Determination and Representation module 126 may cause presentation of the visual indications in the presentation of paths in the representation of the three-dimensional space in which the first robotic appendage and the second robotic appendage operate. For example, the Clearance Determination and Representation module 126 may, for at least one or more of the portions of the first robotic appendage, cause a presentation of a visual indication of a respective amount of clearance between one or more portions of the first robotic appendage and one or more objects in the environment. For example, the Clearance Determination and Representation module 126 may optionally, for at least one or more of the portions of the second robotic appendage, cause a presentation of a visual indication of a respective amount of clearance between one or more portions of the second robotic appendage and one or more objects in the environment. The indications of determined clearance may be spatially associated with respective representations of motion, for example spatially associated with respective edges that represent the transitions that correspond to the motions of the portions of the robotic appendage. The Clearance Determination and Representation module 126 or a Generate Display File(s) module 268 (FIG. 2) may generate image files and forward the image files for presentation. In implementations, the Clearance Determination and Representation module 126 or Generate Display File(s) module 268 may generate separate image files for the roadmap and for the visual indications of determined clearances. The separate images files may, for example be displayed on separate layers of a visual presentation. In other implementations, the Clearance Determination and Representation module 126 or Generate Display File(s) module 268 may generate a unified image file that includes both the roadmap and the visual indications of determined clearances in a single display file.

Optionally at 714, a component of the processor-based system 100, for example a Clearance Determination and Representation module 126 or Receive Input module 270 (FIG. 2), receives input. Input may take a variety of forms, for example instructions or commands to add nodes and/or edges to a roadmap, delete nodes and/or edges from the roadmap, move nodes and/or edges in the roadmap, and/or to set, change or adjust a value of one or more parameters (e.g., speed of movement, path smoothing parameter, cost metric of edge). The Clearance Determination and Representation module 126 or Receive Input module 270 (FIG. 2) may receive input from one or more user input/output devices (e.g., touch screen display 128a).

Optionally at 716, a component of the processor-based system 100, for example a roadmap adjuster 259, adjusts the roadmap 116 for one of the first robotic appendage or the second robotic appendage based at least in part on the determined clearances. Such may, for example, occur autonomously in response to an occurrence of certain defined conditions. Such may, for example, occur in response to received user or operator input, which itself may be based at least in part of the determined clearances. The roadmap adjuster 259 may adjust one or more components of a data structure in which the roadmap 116 is represented in memory or other processor-readable storage.

Optionally at 718, a component of the processor-based system 100 provides the motion plan 115 (FIGS. 1 and 2) for execution by the robotic appendage. For example, a motion planner 110 may provide a motion plan 115 to the first robotic appendage or a robot controller for execution by the first robotic appendage.

The method 700 terminates at 720, for example until invoked again. In some implementations, the method 700 may operate continually or even periodically, for example while at least the first robotic appendage or portion thereof is powered.

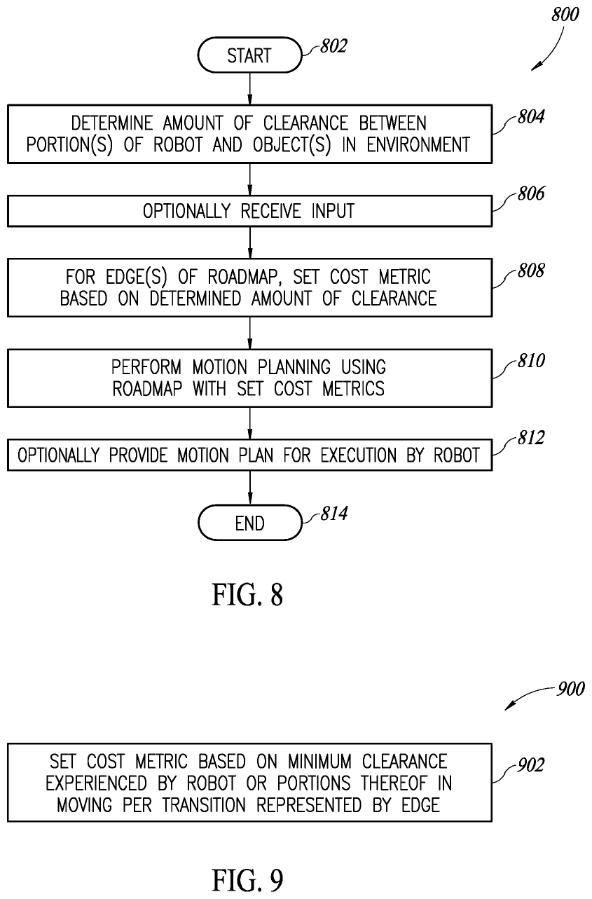

FIG. 8 shows a method 800 of operation in a processor-based system 100 of FIGS. 1 and 2 to determine clearances for one or more portions of a robot that operates in an operational environment, and to set or adjust cost metrics associated with respective edges of a roadmap for the robot, according to at least one illustrated implementation. The method 800 may, for example, be executed by one or more processors 222 (FIG. 2) of a processor-based system 100 (FIG. 1).

The method 800 starts at 802. For example, the method 800 may start in response to a powering ON of a processor-based system 100, a robot control system and/or robot 102, or in response to a call or invocation from a calling routine. The method 800 may execute continually or even continuously, for example during operation of one or more robots 102.

At 804, a component of the processor-based system 100, for example a Clearance Determination and Representation module 126 or Determine Clearances module 264 (FIG. 2), determines an amount of clearance between one or more portions of a robot and one or more objects in the operational environment. For example, for each movement of the robot, and for each of at least one or more portions of the robot, the Clearance Determination and Representation module 126 or Determine Clearances module 264 (FIG. 2) determines a respective amount of clearance between the one or more portions of the robot and one or more objects in an operational environment experienced by the robot or portions thereof in traversing along a path or trajectory of the robot or portions thereof. Notably, the objects may include a second robot that operates in the operational environment.

Optionally at 806, a component of the processor-based system 100, for example a Clearance Determination and Representation module 126 or Receive Input module 270 (FIG. 2), receives input. Input may take a variety of forms, for example instructions or commands to add nodes and/or edges to a roadmap, delete nodes and/or edges from the roadmap, move nodes and/or edges in the roadmap, copy or duplicate nodes or edges in the roadmap, and/or to set, change or adjust a value of one or more parameters (e.g., speed of movement, path smoothing parameter, cost metric of edge). The Clearance Determination and Representation module 126 or Receive Input module 270 (FIG. 2) may receive input from one or more user input/output devices (e.g., touch screen display 128a).

At 808, a component of the processor-based system 100, for example a cost setter 254 sets a cost metric logically associated with a respective edge in a roadmap 116 based at least in part on the determined respective amount of clearance for the motion that corresponds to the edge. The cost metric may, for example, be logically associated with an edge in a data structure that logically represents the roadmap 116 stored in memory or some other processor-readable medium. The cost setter 254 may, for example, set a cost metric for each of one or more edges of a roadmap. The cost setter 254 may, for instance, set a cost metric for edges associated with relatively small or tight clearances at a relatively high value, while the cost setter 254 sets a cost metric for edges associated with relatively large or loose clearances at a relatively low value. This may favor the selection of edges or transitions with relatively larger clearances over those with relatively smaller clearances during motion planning (e.g., during least or lowest cost analysis). Additionally or alternatively, the cost setter 254 may, for example, set a cost metric for edges associated with movement of certain portions of a robot at a relatively high value, while the cost setter 254 sets a cost metric for edges associated with movement of other portions of the robot at a relatively low value. This may favor the selection of edges or transitions with relatively larger clearances for a given portion (e.g., a welding head) of the robot where the clearances with respect to other portions (e.g., elbow) of the robot may not be as stringent. Notably, the cost metric may be set based on a cost function. The cost function may represent one, two or more cost parameters, for example, any one or a combination of: i) collision risk or probability; ii) collision severity; iii) desired amount of clearance iv) latency; v) energy consumption; and/or vi) estimated amount of clearance.

At 810, a component of the processor-based system 100, for example a path analyzer 256, performs motion planning using the roadmap 116 with the cost metrics that, at least in part, represent or are reflective of the determined clearances. The path analyzer 256 can, for example, use any of a large variety of least cost algorithms.

At 812, a component of the processor-based system 100 provides motion plan 115 (FIGS. 1 and 2) for execution by the robot. For example, a motion planner 110 may provide a motion plan to the robot or a robot controller for execution by the robot.

The method 800 then terminates at 814, for example until invoked again. In some implementations, the method 800 may operate continually or even periodically, for example while the robot or portion thereof is powered.

FIG. 9 shows a method 900 of operation in a processor-based system 100 of FIGS. 1 and 2 to set or adjust cost metrics associated with respective edges, according to at least one illustrated implementation. The method 900 may, for example, be executed by one or more processors 222 (FIG. 2) of a processor-based system 100 (FIG. 1), for example as part of the execution of the method 800 (e.g., act 808 of FIG. 8).

At 902, a component of the processor-based system 100, for example a cost setter 254, sets a cost metric logically associated with the respective edge based at least in part on a minimum clearance experienced by the robot or portions thereof in moving according to a transition represented by the respective edge. The cost metric may, for example, be logically associated with an edge in a data structure that logically represents the roadmap stored in memory or some other processor-readable medium.

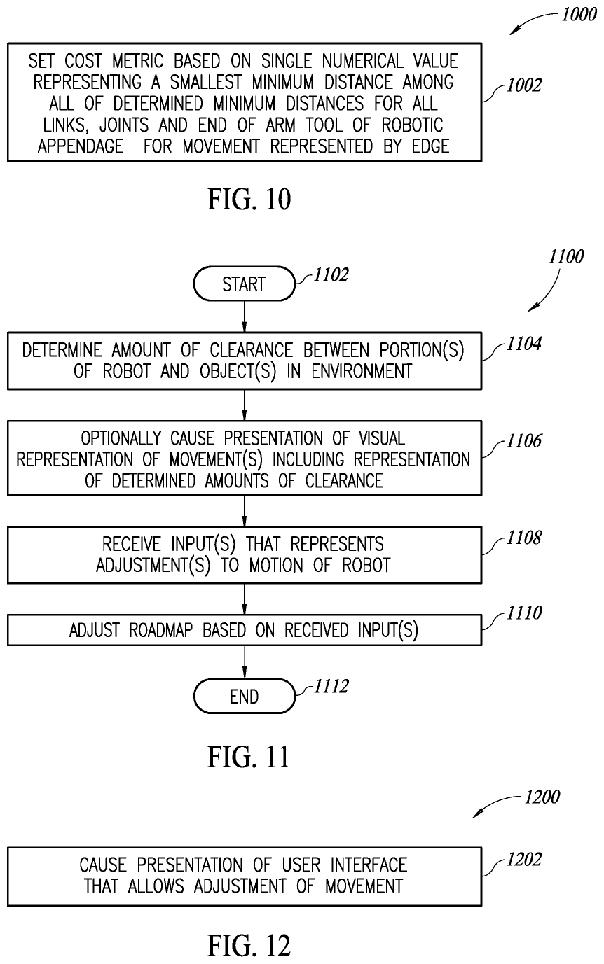

FIG. 10 shows a method 1000 of operation in a processor-based system 100 of FIGS. 1 and 2 to set or adjust cost metrics associated with respective edges, according to at least one illustrated implementation. The method 1000 may, for example, be executed by one or more processors 222 (FIG. 2) of a processor-based system 100 (FIG. 1), for example as part of the execution of the method 800 (e.g., act 808 of FIG. 8).

At 1002, a component of the processor-based system 100, for example a cost setter 254, sets a cost metric logically associated with the respective edge based at least in part on a single numerical value representing a smallest minimum distance among all of the determined minimum distances for all of the links, the joints, the end of arm tool, and optionally cables of the robotic appendage for the movement represented by the respective edge. The cost metric may, for example, be logically associated with an edge in a data structure that logically represents the roadmap stored in memory or some other processor-readable medium.

FIG. 11 shows a method 1100 of operation in a processor-based system 100 of FIGS. 1 and 2 to determine clearances for one or more portions of a robot, to cause a presentation of a representation of movement of the one or more portions of the robot along with visual indications of the determined clearances, receive input, and adjust at least a portion of a roadmap in order to adjust motion of the robot based at least in part on the received input, according to at least one illustrated implementation.

The method 1100 starts at 1102. For example, the method 1100 may start in response to a powering ON of a processor-based system 100, a robot control system and/or a robot 102, or in response to a call or invocation from a calling routine. The method 1100 may execute continually or even continuously, for example during operation of the robot 102.

At 1104, a component of the processor-based system 100, for example a Clearance Determination and Representation module 126 or Determine Clearances module 264 (FIG. 2), determines an amount of clearance between one or more portions of the robot and one or more objects in the operational environment. For example, for each movement of the robot, and for each of one, two, or more portions of the robot, the Clearance Determination and Representation module 126 or Determine Clearances module 264 (FIG. 2) determines a respective amount of clearance between the portion(s) of the robot and the one or more objects in an operational environment 104 (FIG. 1) experienced by the robot or portion thereof in traversing along a path or trajectory of the robot or portion thereof. Notably, the objects may include a second robot that operates in the operational environment.

Optionally at 1106, a component of the processor-based system 100, for example a Clearance Determination and Representation module 126 or a Generate Display File(s) module 268 (FIG. 2), causes a presentation of a representation of one or more movements of the robot along with one or more visual indications of the determined clearances in presentation of the movements of the one or more portions of the robot. For instance, Clearance Determination and Representation module 126 may cause a presentation of paths in a representation of the three-dimensional space in which the robot operates. Also for example, the Clearance Determination and Representation module 126 may cause a presentation of a roadmap for the robot, with edges representing transitions that correspond to the movements or motions. The indications of determined clearance may take a variety of forms, for example numerical values, colors, heat maps, and/or visual cues or visual effects. The indications of determined clearance may be spatially associated with respective representations of motion, for example spatially associated with respective paths that represent the motions or with respective edges that represent the transitions that correspond to the motions. The Clearance Determination and Representation module 126 or Generate Display File(s) module 268 (FIG. 2) may generate image files and forward the image files for presentation. In implementations, the Clearance Determination and Representation module 126 or Generate Display File(s) module 268 (FIG. 2) may generate separate image files for the roadmap and for the visual indications of determined clearances. The separate images files may, for example be displayed on separate layers of a visual presentation. In other implementations, the Clearance Determination and Representation module 126 or Generate Display File(s) module 268 (FIG. 2) may generate a unified image file that includes both the roadmap and the visual indications of determined clearances.

At 1108, a component of the processor-based system 100, for example a Clearance Determination and Representation module 126 or Receive Input module 270 (FIG. 2), receives input. Input may take a variety of forms, for example instructions or commands to add nodes and/or edges to a roadmap, delete nodes and/or edges from the roadmap, move nodes and/or edges in the roadmap, copy or duplicate nodes and/or edges from the roadmap, and/or to set, change or adjust a value of one or more parameters (e.g., speed of movement, path smoothing parameter). The Clearance Determination and Representation module 126 or Receive Input module 270 may receive input from one or more user input/output devices (e.g., touch screen display 128a).

At 1110, a component of the processor-based system 100 adjusts at least a portion of a roadmap based at least in part on the received input. For example, a component of the processor-based system 100 may adjust a speed of one or more movements. In some implementations, a roadmap adjuster 259, adjusts the roadmap for the robot based at least in part on the determined clearances. Such may, for example, occur autonomously in response to an occurrence of certain defined conditions. Such may, for example, occur in response to received user or operator input, which itself may be based at least in part of the determined clearances. The roadmap adjuster 259 may adjust one or more components of a data structure in which the roadmap is represented in memory or other processor-readable storage.

The method 1100 then terminates at 1112, for example until invoked again. In some implementations, the method 1000 may operate continually or even periodically, for example while a robot or portion thereof is powered.

FIG. 12 shows a method 1200 of operation in a processor-based system 100 of FIGS. 1 and 2 to provide a user interface that allows adjustment of movement or motion of one or more robots, according to at least one illustrated implementation. The method 1100 may, for example, be executed by one or more processors 222 (FIG. 2) of a processor-based system 100 (FIG. 1), for instance as part of the execution of any of the methods 500 (FIG. 5), 600 (FIG. 6), 700 (FIG. 7), 800 (FIG. 8), and 1100 (FIG. 11).

At 1202, a component of the processor-based system 100 causes presentation of a user interface that allows adjustment of movement or motion of one or more robots, including for instance adjustment of a roadmap. The user interface may include one or more of: toolbars, pull-down menus, pop-up menus, palettes, scroll bars, radio buttons, fillable fields, dialog boxes, prompts, user selectable icons, and/or other user interface elements. The user interface may, for example allow a user to set values for one or more parameters, for instance controlling one or more of: a speed of movement associated with one or more edges, a value of a path smoothing parameter, and/or a cost metric assigned to one or more edges in the roadmap. The user interface may, for example allow a user to adjust one or more nodes and/or edges in the roadmap, add one or more nodes and/or edges to the roadmap, remove one or more nodes and/or edges from the roadmap, copy or duplicate one or more nodes and/or edges from the roadmap and/or move one or more nodes or edges in the roadmap. The user interface may, for example allow specification of a node or the edge for modification, adjustment or deletion, for instance via use of a unique identifier that uniquely identifies the node or edge, or via selection of the node or edge via a user input/output device. The user interface may, for example, allow the setting or specification of values of one or more parameters for a node or an edge or even the roadmap to be set via a pull-down menu, pop-up menu, dialog box or fillable fields associated with the node, the edge or the roadmap.

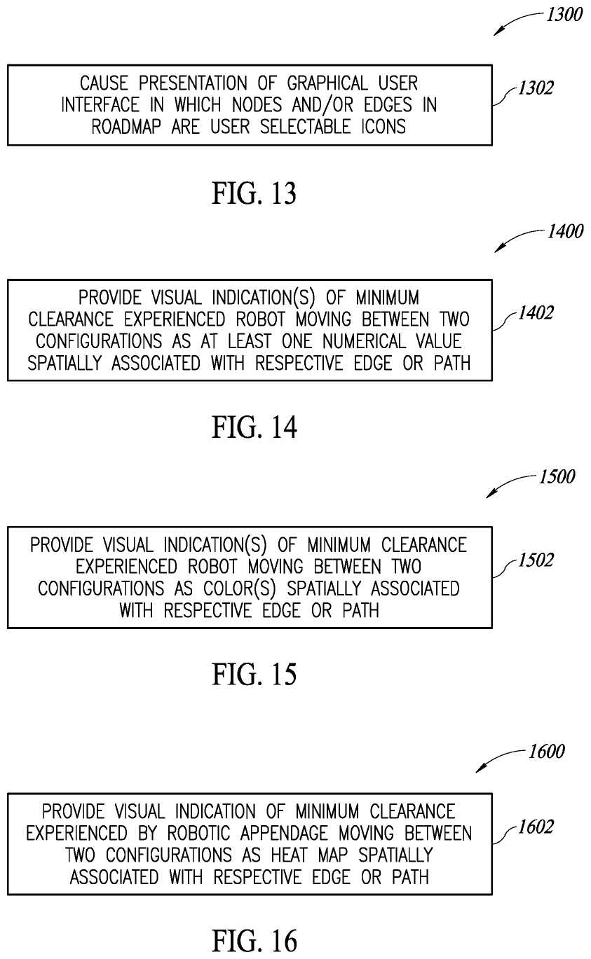

FIG. 13 shows a method 1300 of operation in a processor-based system 100 of FIGS. 1 and 2 to provide a graphical user interface that allows adjustment of movement or motion of one or more robots, according to at least one illustrated implementation. The method 1300 may, for example, be executed by one or more processors 222 (FIG. 2) of a processor-based system 100 (FIG. 1), for instance as part of the execution of any of the methods 500 (FIG. 5), 600 (FIG. 6), 700 (FIG. 7), 800 (FIG. 8), and 1100 (FIG. 11).

At 1302, a component of the processor-based system 100 causes a presentation of a graphical user interface in which nodes and/or edges in a displayed roadmap are user selectable icons. The graphical user interface may include one or more of: toolbars, pull-down menus, pop-up menus, palettes, scroll bars, radio buttons, fillable fields, dialog boxes, prompts, user selectable icons, and/or other user interface elements. In particular, the graphical user interface may include a number of user selectable elements that are components of a roadmap, for example user selectable nodes and/or user selectable edges. Selection of a node or an edge may, for example select the node or the edge for modification, adjustment, copying or duplication, or deletion. Selection of a node or an edge may, for example allow a drag and drop operation to be performed on the selected node or edge. Selection of a node or an edge may, for example, cause presentation of a pop-up menu or dialog box, allowing, for instance, the setting of values for one or more parameters associated with the node, the edge or the roadmap. In some implementations, selection of an edge or path or portion thereof may cause an indication of the determined clearance to be presented as a popup value or color or visual effect.

FIG. 14 shows a method 1400 of operation in a processor-based system 100 of FIGS. 1 and 2 to provide visual indications of determined clearances as numerical values associated with respective edges or paths, according to at least one illustrated implementation. The method 1400 may, for example, be executed by one or more processors 222 (FIG. 2) of a processor-based system 100 (FIG. 1), for instance as part of the execution of any of the methods 500 (FIG. 5), 600 (FIG. 6), 700 (FIG. 7) and 1100 (FIG. 11).

At 1402, a component of the processor-based system 100, for example a Clearance Determination and Representation module 126 or Generate Display File(s) module 268 (FIG. 1), provides a visual indication of a minimum clearance experienced by a robot in moving between two configurations in the form of one or more numerical values (e.g., integers, real numbers). The numerical values may represent an amount of clearance, and may for instance be specified in a defined set of units (e.g., inches, millimeters, centimeters). The numerical values may be spatially associated (e.g., proximate to, with or without lead lines) with respective edges or paths that represents the transition between the two configurations during which the minimum clearance was experienced. For instance, the numeric values may be presented spaced closely to or adjacent or even overlying the respective edge or path, for instance at a start point or end point of an edge or path, and/or at one or more intermediary points along the edge or path between the start point and/or at an end point of the edge or path. Thus, each edge or path may have a single numeric value representing the smallest minimum clearance experienced during a movement that corresponds to the edge or path. Alternatively, each edge or path may have two or more numeric values, representing the minimum clearances experienced by different portions of a robot at different portions of a motion or movement that corresponds to the edge or path.

FIG. 15 shows a method 1500 of operation in a processor-based system 100 of FIGS. 1 and 2 to provide visual indications of determined clearances as colors associated with respective edges or paths, according to at least one illustrated implementation. The method 1500 may, for example, be executed by one or more processors 222 (FIG. 2) of a processor-based system 100 (FIG. 1), for instance as part of the execution of any of the methods 500 (FIG. 5), 600 (FIG. 6), 700 (FIG. 7) and 1100 (FIG. 11).

At 1502, a component of the processor-based system 100, for example a Clearance Determination and Representation module 126 or Generate Display File(s) module 268 (FIG. 1), provides a visual indication of minimum clearance experienced by a robot in moving between two configurations as one or more colors. The colors may represent an amount of clearance (e.g., red less than 1.0 millimeters, green more than 1.0 centimeters). The colors may be spatially associated with respective edges or paths that represents the transition between the two configurations during which the minimum clearance was experienced. For instance, the respective edge or path may be represented in a color that corresponds to the determined clearance. Also for instance, the respective edge or path may be overlaid with a transparent color overlay, where the specific color corresponds to the determined clearance. Thus, each edge or path may have a single color representing the smallest minimum clearance experienced during a movement that corresponds to the edge or path. Alternatively, each edge or path may have two or more colors, representing the minimum clearances experienced by different portions of a robot during a movement that corresponds to the edge or path or experienced at different portions of the corresponding motion or movement.

FIG. 16 shows a method 1600 of operation in a processor-based system 100 of FIGS. 1 and 2 to provide visual indications of determined clearances as a heat map associated with respective edges or paths, according to at least one illustrated implementation. The method 1600 may, for example, be executed by one or more processors 222 (FIG. 2) of a processor-based system 100 (FIG. 1), for instance as part of the execution of any of the methods 500 (FIG. 5), 600 (FIG. 6), 700 (FIG. 7), 800 (FIG. 8), and 1100 (FIG. 11).

At 1602, a component of the processor-based system 100 or Generate Display File(s) module 268 (FIG. 1) provides a visual indication of minimum clearance experienced by a robotic appendage in moving between two configurations as a heat map. The heat map may include different colors, including shades of color, the colors or shades of color representing respective determined clearances (e.g., dark red less than 0.25 millimeters, light red greater than 0.25 millimeters and less than 0.5 millimeters, dark green more than 0.5 millimeters and less than 1.0 millimeters, light green more than 1.0 millimeters and less than 5.0 millimeters). The heat map may be spatially associated with respective edges or paths that represents the transition between the two configurations during which the minimum clearance was experienced. For instance, the respective edge or path may be represented in a heat map that corresponds to the determined clearances. Also for instance, the respective edge or path may be overlaid with a transparent heat map overlay, where the specific colors or shades of the heat map corresponds to the determined clearances. Thus, each edge or path may have a respective heat map representing the minimum clearance experienced during a movement that corresponds to the edge or path.

Providing a heat map for each motion helps draw the attention of a human user or operator to the parts of the motion (e.g., represented by edge in roadmap) that presents a potential problem. So when previewing an edge, the user or operator knows what part of the edge to look at, and more quickly identifies any potential problems. For example, if 1 centimeter of clearance is acceptable, but 5 millimeters of clearance is not acceptable, then color coding those portions of the edge without sufficient clearance (i.e., specified or nominal clearance) differently than other portions of the edge, would render the potential problem more readily apparent, since it is exceptionally difficult to visually detect a difference of 5 millimeters, especially on a computer display screen. If the specified or nominal clearance is violated in the middle of an edge, it immediately tells the user or operator that this might be avoidable with an intermediate node or waypoint. If only the terminal points of an edge are violating the specified or nominal clearance, that may be considered acceptable and unavoidable.

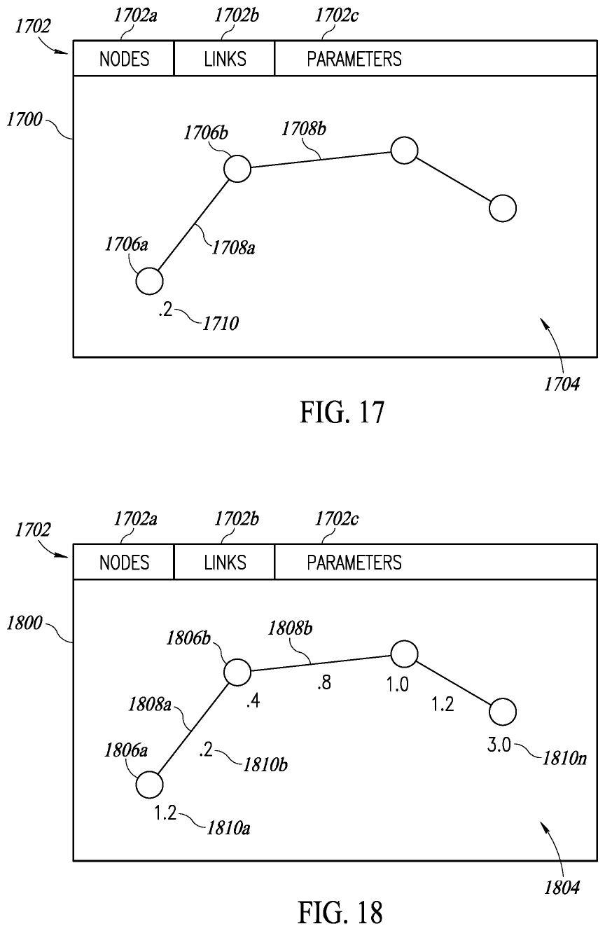

FIG. 17 shows a displayed user interface 1700 showing a presentation of a representation of movement of a robot or portions thereof of along with indications of determined clearances according to at least one illustrated implementation.

The user interface 1700 may include a set of user selectable icons, for example a toolbar 1702 including a number of pull-down menus, for instance a nodes pull-down menu 1702a, an edges pull-down menu 1702b, and a parameter setting pull-down menu 1702c. The nodes pull-down menu 1702a allows nodes of a roadmap to be added, removed, moved, copied, or otherwise modified. The edges pull-down menu 1702b allows edges of a roadmap to be added, removed, moved, coped, or otherwise modified. The parameter setting pull-down menu 1702c allows parameters of a roadmap to be added, removed, moved or otherwise modified.

In particular, the representation of movement is in the form of a roadmap 1704 with a number of nodes 1706a, 1706b (only two called out) and edges 1708a, 1708b (only two called out), and the indications of determined clearances are in the form of a single numeric value 1710 (only one shown) representing a smallest clearance experienced by one or more portions of the robot in executing a movement corresponding to a transition represented by an edge 1708a, 1708b in the roadmap 1704.

FIG. 18 shows a displayed user interface 1800 showing a presentation of a representation of movement of a robot or portions thereof of along with indications of determined clearances according to at least one illustrated implementation.

The user interface 1800 may include a set of user selectable icons, for example a toolbar 1702 including a number of pull-down menus, for instance a nodes pull-down menu 1702a, an edges pull-down menu 1702b, and a parameter setting pull-down menu 1702c, similar or identical to those of FIG. 17. Description of which will not be repeated.

In particular, the representation of movement is in the form of a roadmap 1804 with a number of nodes 1806a, 1806b (only two called out) and edges 1808a, 1808b (only two called out), and the indications of determined clearances are in the form of a plurality of numeric values 1810a, 1810b, 1810n (seven shown, only three called out) representing respective clearances experienced by portions of the robot in executing a movement corresponding to a set of transitions represented by the edges in the roadmap 1804.

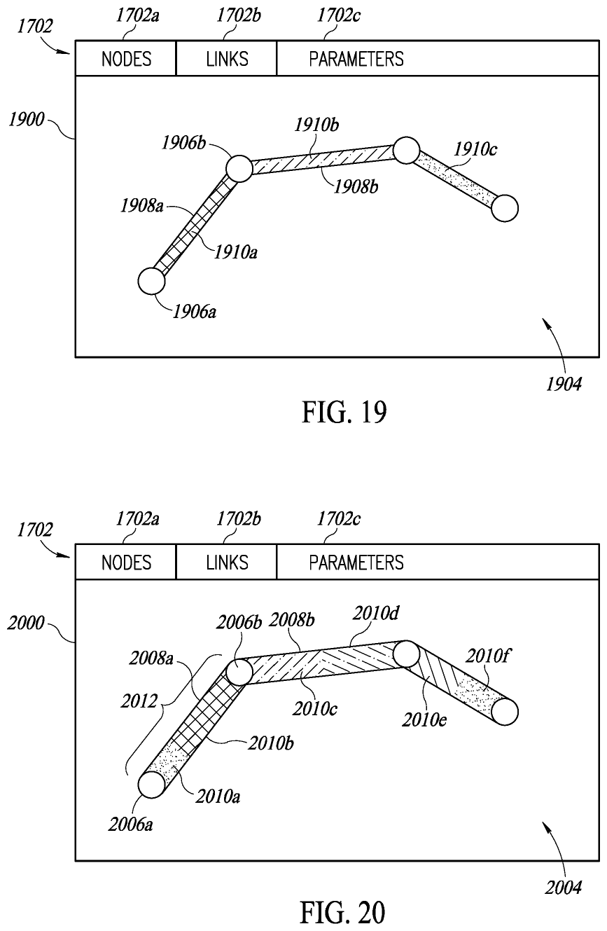

FIG. 19 shows a displayed user interface 1900 showing a presentation of a representation of movement of a robot or portions thereof of along with indications of determined clearances according to at least one illustrated implementation.

The user interface 1900 may include a set of user selectable icons, for example a toolbar 1702 including a number of pull-down menus, for instance a nodes pull-down menu 1702a, an edges pull-down menu 1702b, and a parameter setting pull-down menu 1702c, similar or identical to those of FIG. 17.

In particular, the representation of movement is in the form of a roadmap 1904 with a number of nodes 1906a, 1906b (only two called out) and edges 1908a, 1908b (only two called out), and the indications of determined clearances are in the form of a single color 1910a, 1910b, 1910c (colors represented by cross-hatching, three called out) representing a smallest clearance experienced by one or more portions of the robot in executing a movement corresponding to a transition represented by a respective edge 1908a, 1908b in the roadmap 1904.

FIG. 20 shows a displayed user interface 2000 showing a presentation of a representation of movement of a robot or portions thereof of along with indications of determined clearances according to at least one illustrated implementation.

The user interface 2000 may include a set of user selectable icons, for example a toolbar 1702 including a number of pull-down menus, for instance a nodes pull-down menu 1702a, an edges pull-down menu 1702b, and a parameter setting pull-down menu 1702c, similar or identical to those of FIG. 17.

In particular, the representation of movement is in the form of a roadmap 2004 with a number of nodes 2006a, 2006b (only two called out) and edges 2008a, 2008b (only two called out), and the indications of determined clearances are in the form of a plurality of colors 2010a, 2010b, 2010c, 2010d, 2010e, 2010f (colors including shades of color represented by cross-hatching, six called out) constituting one or more heat maps 2012 (three shown, one called out) representing respective clearances experienced one or more portions of the robot in executing a movement corresponding to a set of transitions represented by the edges 2008a, 2008b in the roadmap 2004.

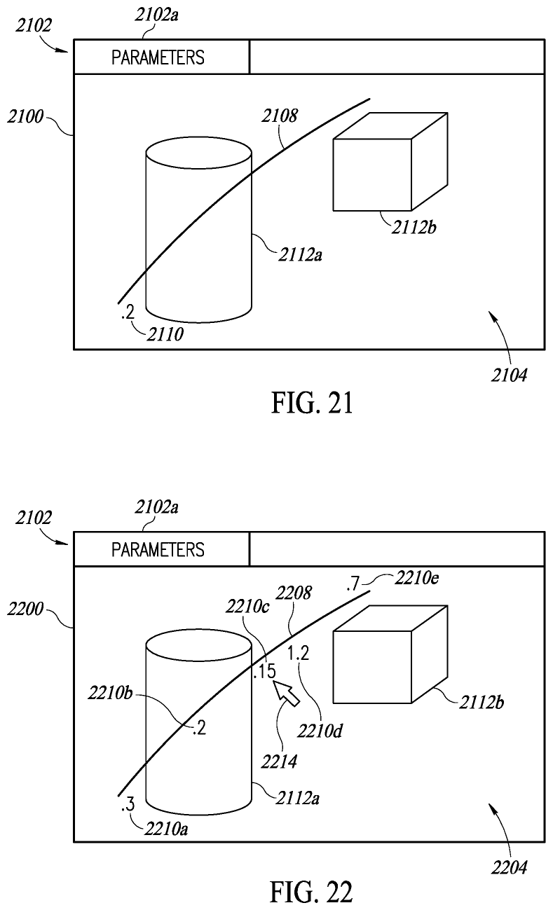

FIG. 21 shows a displayed user interface 2100 showing a presentation of a representation of movement of a robot or portions thereof along with indications of determined clearances according to at least one illustrated implementation.

The user interface 2100 may include a set of user selectable icons, for example a toolbar 2102 including a number of pull-down menus, for instance a parameter setting pull-down menu 2102a.

In particular, the representation of movement is in the form of one or more paths 2108 (one shown) in a representation of a three-dimensional operational environment 2104, and the indications of determined clearances are in the form of a single numeric value 2110 representing a smallest clearance experienced by the robot in executing movements represented by the path 2108 in the representation of the three-dimensional operational environment 2104. The single numeric value 2110 is presented spatially associated with the path 2108, for example proximate or adjacent thereto with or without a lead line. The representation of the three-dimensional operational environment 2104 may include representations of one or more objects 2112a, 2112b (two shown) present in the operational environment.

FIG. 22 shows a displayed user interface 2200 showing a presentation of a representation of movement of a robot or portions thereof along with indications of determined clearances according to at least one illustrated implementation.

The user interface 2200 may include a set of user selectable icons, for example a toolbar 2102 including a number of pull-down menus, for instance a parameter setting pull-down menu 2102a, similar or identical to those of FIG. 21.

In particular, the representation of movement is in the form of one or more paths 2208 (one shown) in a representation of a three-dimensional operational environment 2204, and the indications of determined clearances are in the form of a plurality of numeric values 2210a, 2210b, 2210c, 2210d, 2210e (five shown) representing respective clearances experienced by the robot in executing movements represented by the paths 2208 in the representation of the three-dimensional operational environment 2204. The numeric values 2210a, 2210b, 2210c, 2210d, 2210e are presented spatially associated with respective portions of the path 2108, for example proximate or adjacent thereto with or without a lead line. The representation of the three-dimensional operational environment 2204 may include representations of one or more objects 2112a, 2112b (two shown) present in the operational environment.

Also illustrated in FIG. 22 is a cursor 2214, which may be controlled by a user or operator to select a user selectable icon (e.g., path 2208 or portion thereof, parameter setting pull-down menu 2102a) via one or more input/output devices (e.g., touch screen display 128a). Selecting a path 2208 may, for example, cause presentation of a popup menu or dialog box presenting information about the path and/or allowing modification of values of various parameters associated with the path 2208. Selecting a portion of a path 2208 may, for example, cause presentation of a clearance value that corresponds to the portion of a motion that corresponds to the selected portion of the path 2208. Selection of a path 2208 may be done by placement of the cursor 2214 over a portion of the path 2208 along with a single click. Selection of a portion of a path 2208 may be done by placement of the cursor 2214 over a portion of the path 2208 along with a double click, allowing differentiation from selection of the entire path 2208.

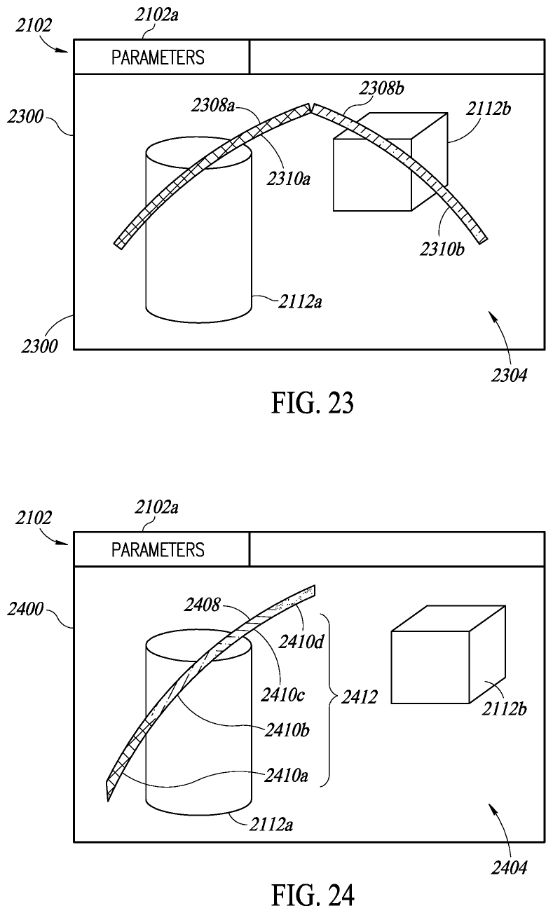

FIG. 23 is an image of a displayed user interface 2300 showing a presentation of a representation of movement of a robot or portions thereof along with indications of determined clearances according to at least one illustrated implementation.

The user interface 2300 may include a set of user selectable icons, for example a toolbar 2102 including a number of pull-down menus, for instance a parameter setting pull-down menu 2102a, similar or identical to those of FIG. 21.

In particular, the representation of movement is in the form of one or more paths 2308a, 2308b (two shown) in a representation of a three-dimensional operational environment 2304, and the indications of determined clearances are in the form of a single color (e.g., a first color 2310a, a second color 2310b, color indicated by cross-hatching) representing a smallest clearance experienced by the robot in executing movements represented by respective ones of the paths 2308a, 2308b in the representation of the three-dimensional operational environment. The representation of the three-dimensional operational environment 2304 may include representations of one or more objects 2112a, 2112b (two shown) present in the operational environment.

FIG. 24 shows a displayed user interface 2400 showing a presentation of a representation of movement of a robot or portions thereof along with indications of determined clearances according to at least one illustrated implementation.

The user interface 2400 may include a set of user selectable icons, for example a toolbar 2102 including a number of pull-down menus, for instance a parameter setting pull-down menu 2102a, similar or identical to those of FIG. 21.

In particular, the representation of movement is in the form of one or more paths 2408 (one shown) in a representation of a three-dimensional operational environment 2404, and the indications of determined clearances are in the form of a plurality of colors 2410a, 2410b, 2410c, 2410d (colors including shades of color represented by cross-hatching, four shown) constituting a heat map 2412 representing respective clearances experienced by the robot in executing movements represented by the path 2408 in the representation of the three-dimensional operational environment 2404. The representation of the three-dimensional operational environment 2404 may include representations of one or more objects 2112a, 2112b (two shown) present in the operational environment.

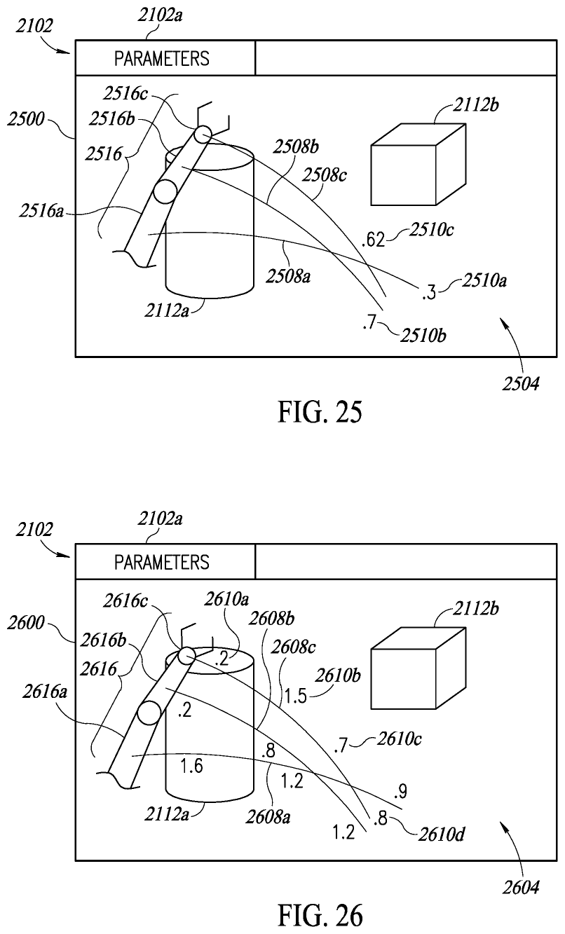

FIG. 25 shows a displayed user interface 2500 showing a presentation of a representation of movement of two or more portions of a robot along with indications of determined clearances according to at least one illustrated implementation.

The user interface 2500 may include a set of user selectable icons, for example a toolbar 2102 including a number of pull-down menus, for instance a parameter setting pull-down menu 2102a, similar or identical to those of FIG. 21.

In particular, the representation of movement is in the form of two or more paths 2508a, 2508b, 2508c (three shown) of respective portions 2516a, 2516b, 2516c (three called out) of a robotic appendage 2516 in a representation of a three-dimensional operational environment 2504, and the indications of determined clearances are in the form of a single numeric value 2510a, 2510b, 2510c (three shown, one for each path 2508a, 2508b, 2508c) representing a smallest clearance experienced by each of the two or more portions of the robot in executing movements represented by the paths 2508a, 2508b, 2508c in the representation of the three-dimensional operational environment 2504. The values 2510a, 2510b, 2510c may be spatially associated with respective ones of the paths 2508a, 2508b, 2508c, for instance proximate or adjacent therewith, with or without lead lines. The representation of the three-dimensional operational environment 2504 may include representations of one or more objects 2112a, 2112b (two shown) present in the operational environment.

FIG. 26 shows a displayed user interface 2600 showing a presentation of a representation of movement of two or more portions of a robot along with indications of determined clearances according to at least one illustrated implementation.

The user interface 2600 may include a set of user selectable icons, for example a toolbar 2102 including a number of pull-down menus, for instance a parameter setting pull-down menu 2102a, similar or identical to those of FIG. 21.

In particular, the representation of movement is in the form of two or more paths 2608a, 2608b, 2608c (three shown) of respective portions 2616a, 2616b, 2616c (three called out) of a robotic appendage 2616 in a representation of a three-dimensional operational environment 2604. The indications of determined clearances are in the form of a plurality of numeric values 2610a, 2610b, 2610c, 2610d (four illustrated for each path, one set of four called out for one of the paths 2608c for drawing legibility) for each of the paths 2608a, 2608b, 2608c, the numeric values 2610a, 2610b, 2610c, 2610d representing respective clearances experienced by each of the two or more portions of the robot in executing movements represented by the paths 2608a, 2608b, 2608c in the representation of the three-dimensional operational environment 2604. The values 2610a, 2610b, 2610c, 2610d may be spatially associated with respective ones of the paths 2608c, for instance proximate or adjacent therewith, with or without lead lines. The representation of the three-dimensional operational environment 2604 may include representations of one or more objects 2112a, 2112b (two shown) present in the operational environment.

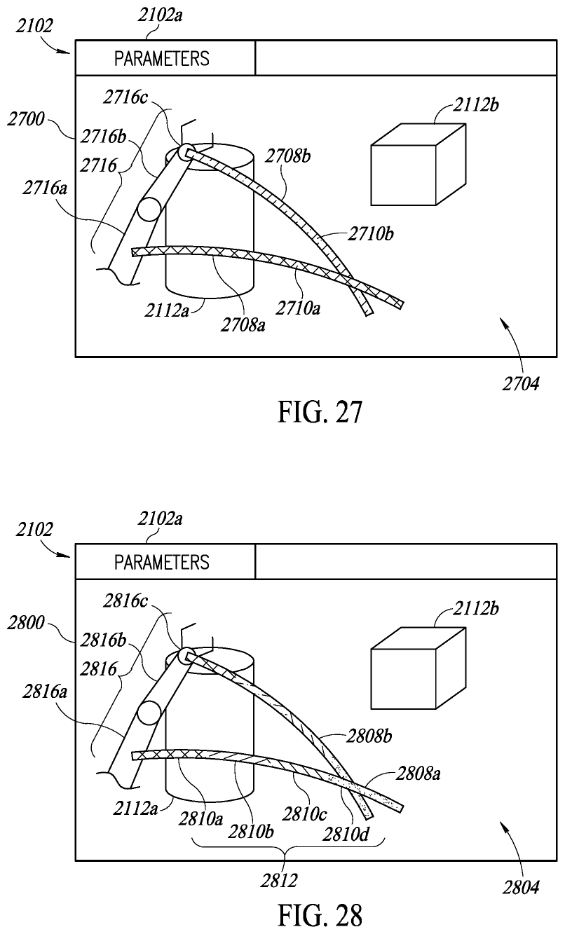

FIG. 27 shows a displayed user interface 2700 showing a presentation of a representation of movement of two or more portions of a robot of along with indications of determined clearances according to at least one illustrated implementation.

The user interface 2700 may include a set of user selectable icons, for example a toolbar 2102 including a number of pull-down menus, for instance a parameter setting pull-down menu 2102a, similar or identical to those of FIG. 21.

In particular, the representation of movement is in the form of two or more paths 2708a, 2708b (two shown) of respective portions 2716a, 2716c (two called out) of a robotic appendage 2716 in a representation of a three-dimensional operational environment 2704, and the indications of determined clearances are in the form of a single color 2710a, 2710b for each path 2708a, 2708b, the single colors representing a smallest clearance experienced by each of the two or more portions 2716a, 2716c of the robot 2716 in executing movements represented by the paths 2708a, 2708b in the representation of the three-dimensional operational environment 2704. The representation of the three-dimensional operational environment 2704 may include representations of one or more objects 2112a, 2112b (two shown) present in the operational environment.

FIG. 28 shows a displayed user interface 2800 showing a presentation of a representation of movement of two or more portions of a robot along with indications of determined clearances according to at least one illustrated implementation.

The user interface 2800 may include a set of user selectable icons, for example a toolbar 2102 including a number of pull-down menus, for instance a parameter setting pull-down menu 2102a, similar or identical to those of FIG. 21.

In particular, the representation of movement is in the form of two or more paths 2808a, 2808b (two shown) of respective portions 2816a, 2816c (two called out) of a robotic appendage 2816 in a representation of a three-dimensional operational environment 2804, and the indications of determined clearances are in the form of a plurality of colors 2810a, 2810b, 2810c, 2810d (colors including shades of color represented by cross-hatching, four called out for one path 2808a) constituting one or more heat maps 2812 (two shown, one called out) representing respective clearances experienced by each of the two or more portions 2816a, 2816c of the robot 2816 in executing movements represented by the paths 2808a, 2808b in the representation of the three-dimensional operational environment 2804. The representation of the three-dimensional operational environment 2804 may include representations of one or more objects 2112a, 2112b (two shown) present in the operational environment.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Boolean circuits, Application Specific Integrated Circuits (ASICs) and/or FPGAs. However, those skilled in the art will recognize that the embodiments disclosed herein, in whole or in part, can be implemented in various different implementations in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

The various embodiments described above can be combined to provide further embodiments. All of the commonly assigned US patent application publications, US patent applications, foreign patents, and foreign patent applications referred to in this specification and/or listed in the Application Data Sheet, including but not limited International Patent Application No. PCT/US2017/036880, filed Jun. 9, 2017, entitled “MOTION PLANNING FOR AUTONOMOUS VEHICLES AND RECONFIGURABLE MOTION PLANNING PROCESSORS”; International Patent Application Publication No. WO 2016/122840, filed Jan. 5, 2016, entitled “SPECIALIZED ROBOT MOTION PLANNING HARDWARE AND METHODS OF MAKING AND USING SAME”; U.S. Patent Application No. 62/616,783, filed Jan. 12, 2018, entitled, “APPARATUS, METHOD AND ARTICLE TO FACILITATE MOTION PLANNING OF AN AUTONOMOUS VEHICLE IN AN ENVIRONMENT HAVING DYNAMIC OBJECTS”; U.S. Patent Application No. 62/626,939, filed Feb. 6, 2018, entitled “MOTION PLANNING OF A ROBOT STORING A DISCRETIZED ENVIRONMENT ON ONE OR MORE PROCESSORS AND IMPROVED OPERATION OF SAME”; U.S. Patent Application No. 62/856,548, filed Jun. 3, 2019, entitled “APPARATUS, METHODS AND ARTICLES TO FACILITATE MOTION PLANNING IN ENVIRONMENTS HAVING DYNAMIC OBSTACLES”; U.S. Patent Application No. 62/865,431, filed Jun. 24, 2019, entitled “MOTION PLANNING FOR MULTIPLE ROBOTS IN SHARED WORKSPACE”; International Patent Application No. PCT/US2020/039193, filed Jun. 23, 2020, entitled “MOTION PLANNING FOR MULTIPLE ROBOTS IN SHARED WORKSPACE”; U.S. Patent Application No. 63/105,542, filed Oct. 26, 2020, entitled “SAFETY SYSTEMS AND METHODS EMPLOYED IN ROBOT OPERATIONS”; and/or U.S. Patent Application No. 63/120,412, filed Dec. 2, 2020, entitled “SYSTEMS, METHODS, AND USER INTERFACES EMPLOYING CLEARANCE DETERMINATIONS IN ROBOT MOTION PLANNING AND CONTROL” as suitably modified to operate as described herein, are each incorporated herein by reference, in their entirety. These and other changes can be made to the embodiments in light of the above-detailed description.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of motion planning, the method comprising:
for at least one movement of a robot, for each of at least one or more portions of the robot, determining a respective amount of clearance between the portion of the robot and one or more objects in an operational environment;
causing a presentation of a roadmap for movement of the robot in a form of a graph having a plurality of nodes and a plurality of edges, each edge coupling the nodes of a respective pair of nodes, the nodes representing respective configurations of the robot, and the edges representing a respective transition between a respective pair of the configurations of the robot represented by the nodes of the pair of nodes coupled by the respective edge; and
for at least one or more of the portions of the robot, causing a presentation of a visual indication of the determined amount of clearance in the presentation of the roadmap.

2. The method of claim 1 wherein the robot includes a robotic appendage comprising at least two links, at least one joint and an end of arm tool, and causing a presentation of a visual indication of the determined amount of clearance in the presentation of the roadmap includes causing a presentation of a visual indication of the determined amount of clearance in the presentation of the roadmap for all of the links, the joints and the end of arm tool of the robotic appendage.

3. The method of claim 1 wherein the robot includes a robotic appendage comprising at least two links, at least one joint, at least one cable, and an end of arm tool, and causing a presentation of a visual indication of the determined amount of clearance in the presentation of the roadmap includes causing a presentation of a visual indication of the determined amount of clearance in the presentation of the roadmap for an entirety of the robotic appendage.

4. The method of claim 1 wherein causing a presentation of a visual indication of the determined amount of clearance in the presentation of the roadmap includes providing a visual indication of a minimum clearance experienced by any portion of the robot in moving between two configurations that are represented as a respective pair of nodes connected by a respective edge.

5. The method of claim 1 wherein causing a presentation of a visual indication of the determined amount of clearance in the presentation of the roadmap includes providing a visual indication of a minimum clearance experienced by at least one portion of the robot in moving between two configurations as at least one numerical value spatially associated with a respective one of the edges that represents the transition between the two configurations.

6. The method of claim 1 wherein the robot includes a robotic appendage comprising at least two links, at least one joint and an end of arm tool, and causing a presentation of a visual indication of the determined amount of clearance in the presentation of the roadmap includes providing a visual indication of a minimum clearance experienced by any portion of the robotic appendage in moving between two configurations as a single numerical value spatially associated with a respective one of the edges that represents the transition between the two configurations, the single numerical value representing a smallest minimum distance among all of the determined minimum distances for all of the links, the joints and the end of arm tool of the robotic appendage for the movement represented by the respective one of the edges.

7. The method of claim 1 wherein the robot includes a robotic appendage comprising at least two links, at least one joint and an end of arm tool, and causing a presentation of a visual indication of the determined amount of clearance in the presentation of the roadmap includes providing a visual indication of a minimum clearance experienced by any portion of the robotic appendage in moving between two configurations as a plurality of numerical values spatially associated with the edge, the plurality of numerical values representing the determined minimum distances for all of the links, the joints and the end of arm tool of the robotic appendage at respective ones of three or more poses of the robotic appendage which the robotic appendage assumes in transitioning between the configurations represented by the nodes of the pair of nodes connected by the edge.

8. The method of claim 1 wherein causing a presentation of a visual indication of the determined amount of clearance in the presentation of the roadmap includes providing a visual indication of a minimum clearance experienced by at least one portion of the robot in moving between two configurations as one or more colors spatially associated with a respective one of the edges that represents the transition between the two configurations, each color representative of an amount of clearance.

9. The method of claim 1 wherein the robot includes a robotic appendage comprising at least two links, at least one joint and an end of arm tool, and causing a presentation of a visual indication of the determined amount of clearance in the presentation of the roadmap includes providing a visual indication of a minimum clearance experienced by any portion of the robotic appendage in moving between two configurations as a single color spatially associated with a respective one of the edges that represents the transition between the two configurations, the single color representing a smallest minimum distance among all of the determined minimum distances for all of the links, the joints and the end of arm tool of the robotic appendage for the movement represented by the respective edge.

10. The method of claim 1 wherein the robot includes a robotic appendage comprising at least two links, at least one joint and an end of arm tool, and causing a presentation of a visual indication of the determined amount of clearance in the presentation of the roadmap includes providing a visual indication of a minimum clearance experienced by any portion of the robotic appendage in moving between two configurations as a plurality of colors spatially associated with a respective one of the edges that represents the transition between the two configurations, the plurality of colors representing the determined minimum distances for all of the links, the joints and the end of arm tool of the robotic appendage at respective ones of three or more poses of the robotic appendage which the robotic appendage assumes in transitioning between the configurations represented by the nodes of the pair of nodes connected by the respective one of the edges.

11. The method of claim 1 wherein the robot includes a robotic appendage comprising at least two links, at least one joint and an end of arm tool, and causing a presentation of a visual indication of the determined amount of clearance in the presentation of the roadmap includes providing a visual indication of a minimum clearance experienced by any portion of the robotic appendage in moving between two configurations as a heat map spatially associated with a respective one of the edges that represents the transition between the two configurations, the heat map representing the determined minimum distances for all of the links, the joints and the end of arm tool of the robotic appendage at respective ones of three or more poses of the robotic appendage which the robotic appendage assumes in transitioning between the configurations represented by the nodes of the pair of nodes connected by the respective one of the edges.

12. The method of claim 1 wherein determining a respective amount of clearance between the portion of the robot and one or more objects in an operational environment includes determining a respective amount of clearance between the portion of the robot and a portion of another robot that operates in the operational environment.

13. (canceled)

14. A system for use in motion planning, the system comprising:
at least one processor; and
at least one non-transitory processor-readable medium that stores processor-executable instructions which, when executed by the at least one processor, cause the at least one processor to:
for at least one movement of a robot, for each of at least one or more portions of the robot, determine a respective amount of clearance between the portion of the robot and one or more objects in an operational environment;
cause a presentation of a roadmap for movement of the robot in a form of a graph having a plurality of nodes and a plurality of edges, each edge coupling the nodes of a respective pair of nodes, the nodes representing respective configurations of the robot, and the edges representing a respective transition between a respective pair of the configurations of the robot represented by the nodes of the pair of nodes coupled by the respective edge; and
for at least one or more of the portions of the robot, cause a presentation of a visual indication of the determined amount of clearance in the presentation of the roadmap.

15. The system of claim 14 wherein the robot includes a robotic appendage comprising at least two links, at least one joint and an end of arm tool, and to cause a presentation of a visual indication of the determined amount of clearance in the presentation of the roadmap, the processor-executable instructions cause the at least one processor to cause presentation of a visual indication of the determined amount of clearance in the presentation of the roadmap for all of the links, the joints and the end of arm tool of the robotic appendage.

16. The system of claim 14 wherein the robot includes a robotic appendage comprising at least two links, at least one joint, at least one cable, and an end of arm tool, and to cause a presentation of a visual indication of the determined amount of clearance in the presentation of the roadmap, the processor-executable instructions cause the at least one processor to cause a presentation of a visual indication of the determined amount of clearance in the presentation of the roadmap for an entirety of the robotic appendage.

17. The system of claim 14 wherein to cause a presentation of a visual indication of the determined amount of clearance in the presentation of the roadmap, the processor-executable instructions cause the at least one processor to cause presentation of a visual indication of a minimum clearance experienced by any portion of the robot in moving between two configurations that are represented as a respective pair of nodes connected by a respective edge.

18. The system of claim 14 wherein to cause a presentation of a visual indication of the determined amount of clearance in the presentation of the roadmap, the processor-executable instructions cause the at least one processor to cause presentation of a visual indication of a minimum clearance experienced by at least one portion of the robot in moving between two configurations as at least one numerical value spatially associated with a respective one of the edges that represents the transition between the two configurations.

19. The system of claim 14 wherein the robot includes a robotic appendage comprising at least two links, at least one joint and an end of arm tool, and to cause a presentation of a visual indication of the determined amount of clearance in the presentation of the roadmap, the processor-executable instructions cause the at least one processor to cause presentation of a visual indication of a minimum clearance experienced by any portion of the robotic appendage in moving between two configurations as a single numerical value spatially associated with a respective one of the edges that represents the transition between the two configurations, the single numerical value representing a smallest minimum distance among all of the determined minimum distances for all of the links, the joints and the end of arm tool of the robotic appendage for the movement represented by the respective one of the edges.

20. The system of claim 14 wherein the robot includes a robotic appendage comprising at least two links, at least one joint and an end of arm tool, and to cause a presentation of a visual indication of the determined amount of clearance in the presentation of the roadmap, the processor-executable instructions cause the at least one processor to cause presentation of a visual indication of a minimum clearance experienced by any portion of the robotic appendage in moving between two configurations as a plurality of numerical values spatially associated with the edge, the plurality of numerical values representing the determined minimum distances for all of the links, the joints and the end of arm tool of the robotic appendage at respective ones of three or more poses of the robotic appendage which the robotic appendage assumes in transitioning between the configurations represented by the nodes of the pair of nodes connected by the edge.

21. The system of claim 14 wherein to cause a presentation of a visual indication of the determined amount of clearance in the presentation of the roadmap, the processor-executable instructions cause the at least one processor to cause presentation of a visual indication of a minimum clearance experienced by at least one portion of the robot in moving between two configurations as one or more colors spatially associated with a respective one of the edges that represents the transition between the two configurations, each color representative of an amount of clearance.

22. The system of claim 14 wherein the robot includes a robotic appendage comprising at least two links, at least one joint and an end of arm tool, and to cause a presentation of a visual indication of the determined amount of clearance in the presentation of the roadmap, the processor-executable instructions cause the at least one processor to cause presentation of a visual indication of a minimum clearance experienced by any portion of the robotic appendage in moving between two configurations as a single color spatially associated with a respective one of the edges that represents the transition between the two configurations, the single color representing a smallest minimum distance among all of the determined minimum distances for all of the links, the joints and the end of arm tool of the robotic appendage for the movement represented by the respective edge.

23. The system of claim 14 wherein the robot includes a robotic appendage comprising at least two links, at least one joint and an end of arm tool, and to cause a presentation of a visual indication of the determined amount of clearance in the presentation of the roadmap, the processor-executable instructions cause the at least one processor to cause presentation of a visual indication of a minimum clearance experienced by any portion of the robotic appendage in moving between two configurations as a plurality of colors spatially associated with a respective one of the edges that represents the transition between the two configurations, the plurality of colors representing the determined minimum distances for all of the links, the joints and the end of arm tool of the robotic appendage at respective ones of three or more poses of the robotic appendage which the robotic appendage assumes in transitioning between the configurations represented by the nodes of the pair of nodes connected by the respective one of the edges.

24. The system of claim 14 wherein the robot includes a robotic appendage comprising at least two links, at least one joint and an end of arm tool, and to cause a presentation of a visual indication of the determined amount of clearance in the presentation of the roadmap, the processor-executable instructions cause the at least one processor to cause presentation of a visual indication of a minimum clearance experienced by any portion of the robotic appendage in moving between two configurations as a heat map spatially associated with a respective one of the edges that represents the transition between the two configurations, the heat map representing the determined minimum distances for all of the links, the joints and the end of arm tool of the robotic appendage at respective ones of three or more poses of the robotic appendage which the robotic appendage assumes in transitioning between the configurations represented by the nodes of the pair of nodes connected by the respective one of the edges.

25. The system of claim 14 wherein to determine a respective amount of clearance between the portion of the robot and one or more objects in an operational environment that at least one processor determines a respective amount of clearance between the portion of the robot and a portion of another robot that operates in the operational environment.

26.-90. (canceled)

91. The method of claim 1, further comprising:
receiving at least one input that represents at least one adjustment to a motion of the robot; and
adjusting a roadmap for the robot based at least in part on the received at least one input.

92.-97. (canceled)

98. The method of claim 91, further comprising:
causing a presentation of a user interface that allows a user to one or more of: adjust a speed of movement associated with one or more edges, adjust a value of a path smoothing parameter, adjust one or more nodes in the graph, and add one or more nodes to the graph.

99. The method of claim 91 wherein causing a presentation of a roadmap in a form of a graph having a plurality of nodes and a plurality of edges includes causing a presentation of a graphical user interface in which the nodes and the edges in the graph are user selectable icons.

100. (canceled)

101. The system of claim 14 wherein,
when executed by the at least one processor, the processor-executable instructions cause the at least one processor to:
receive at least one input that represents at least one adjustment to a motion of the robot; and
adjust a roadmap for the robot based at least in part on the received at least one input.

102.-107. (canceled)

108. The system of claim 100 wherein, when executed by the at least one processor, the processor-executable instructions cause the at least one processor to:
cause a presentation of a user interface that allows a user to one or more of: adjust a speed of movement associated with one or more edges, adjust a value of a path smoothing parameter, adjust one or more nodes in the graph, and add one or more nodes to the graph.

109. The system of claim 100 wherein to cause a presentation of a roadmap in a form of a graph having a plurality of nodes and a plurality of edges the processor-executable instructions, when executed, cause the at least one processor to cause a presentation of a graphical user interface in which the nodes and the edges are user selectable icons.
